(19) United States
(12) Patent Application Publication
(10) Pub. No.: US 2005/0271864 A1
(43) Pub. Date: Dec. 8, 2005

(54) Method of providing printable decorative labels for customization of portable electronic devices

(76) Inventors: Sjoerd Johannes van Driesten, Bodegraven (NL); Nicoline Hermans, Noordwijk (NL)

Correspondence Address: RENNER, OTTO, BOISSELLE & SKLAP, LLP, 1621 EUCLID AVE, 19TH FL, CLEVELAND, OH, 44115-2191, US

(21) Appl. No.: 11/141,452

(22) Filed: May 31, 2005

Related U.S. Application Data
(60) Provisional application No. 60/577,840, filed on Jun. 8, 2004.

(51) Int. Cl. B32B 33/00

(52) U.S. Cl. 428/195.1

(57) ABSTRACT

Disclosed in one embodiment is a method of personalizing a portable electronic device, including: providing a portable electronic device having a front surface and a rear surface; providing a sheet having a printable front surface and an adhesive coated rear surface, the sheet being divisible into one or more conformable label; providing in electronic format a plurality of images printable by a printer; selecting one or more image for printing from the plurality of images; printing the selected one or more image on the printable surface of the one or more conformable label; separating the printed one or more conformable label from the sheet; and conformably applying the printed one or more conformable label to the surface of the portable electronic device. Also disclosed are a system, a decorated substrate and a printable conformable label and a method for providing a decorative label for, e.g., personalizing a portable electronic device.

### CROSS-REFERENCE TO RELATED APPLICATION

The present application is based on and claims priority under 35 U.S.C. §119(e) to U.S. Provisional Application No. 60/577,840, filed 08 Jun. 2004, the entirety of which is incorporated herein by reference.

### TECHNICAL FIELD

This invention relates to color printable decorative labels for customization of portable electronic devices, methods of providing the same and methods of customization of portable electronic devices.

### BACKGROUND

With the proliferation of electronic devices, especially portable electronic devices, such as, cell phones, hand-held personal computers (PC), MP3 players, CD players, and so forth, these devices have gained the status of personal expressions of a person's dreams, desires, beliefs and/or current interests. As a result, increasingly, users desire to personalize these devices with images representing such personal expressions. For example, in addition to a wide variety of body casing colors, interchangeable faceplates of various colors and artistic designs are available for a variety of mobile phones to allow the users to have even greater choices providing different physical appearances to their own devices. Additionally, a variety of non-standard screen-savers and ring tones can be downloaded into the devices to further personalize the devices. Similarly, hand-held personal computers and personal digital assistants also come in various colors, with various screen savers and wallpapers.

These approaches to personalization suffer from a number of disadvantages. First, the faceplate and other surfacial elements of the portable electronic devices are not easily changeable at the whim of the user. For example, a user must go to a retail outlet or to an online e-commercial site to shop and purchase, e.g., a cell phone faceplate with design and/or color that is currently of interest to the user. Such cell phone faceplates, currently, cost from about US$10 to US$30 or more, depending on the model and cell phone manufacturer. These faceplates are, by design, not interchangeable from one model cell phone to another. Thus, the user must expend a significant amount of money to change the appearance of the portable electronic device. If the user should change cell phones or cell phone service provider, the user is faced with an expenditure for such customized appearance, in addition to the other costs associated with the changes. In addition, the process of changing faceplates is cumbersome for many users, especially for the more novice users, as the proliferation of mobile electronic devices reaches more and more users. Moreover, these approaches to changing faceplates do not facilitate quick and timely changes to the personality to be taken on by the mobile electronic devices. These shortcomings apply equally to personalization of other portable electronic devices, such as MP3 players (and iPOD®), CD players, and game consoles (e.g., XBOX®).

Decorative labels for devices such as cell phones have been made available in commercial outlets, such as kiosks in shopping malls and other public places. However, to obtain such decorative labels, the user of a portable electronic device must travel to the commercial outlet to purchase such labels, and then is restricted to the choices made available by the vendor. In addition, the decorative labels thus available are not easily applicable to a wide variety of devices, and are not known to be easily conformable to the variety of surfaces of portable electronic devices, many of which have irregularities or discontinuities, so that such labels have a problem of forming folds or creases when applied to such devices. Many such labels are not conformable and are not easily removable from the device.

Thus, an improved approach to provide users with better personalization for use with such personal electronic devices would be desirable.

### SUMMARY

In one embodiment, the present invention relates to a method of personalizing a portable electronic device, including:
providing a portable electronic device having a front surface and a rear surface;
providing a sheet having a printable front surface and an adhesive coated rear surface, the sheet being divisible into one or more conformable label, wherein the conformable label comprises a conformable film comprising a stress relaxation in the range from about 1 to about 12 Newtons;
providing in electronic format a plurality of images printable by a printer;
selecting one or more image for printing from the plurality of images;
printing the selected one or more image on the printable surface of the sheet;
separating one or more printed conformable label from the sheet; and
conformably applying the one or more printed conformable label to the rear surface of the portable electronic device.

In one embodiment, the sheet is divisible by being pre-cut into one or more conformable label having a predetermined size.

In one embodiment, the conformable label is applied to the rear surface of the portable electronic device.

In one embodiment, the portable electronic device includes, for example, one of a telephone or telephone handset, a cellular telephone, a radio telephone, a walkie-talkie, a personal digital assistant, a handheld, notebook or desktop computer, a digital camera, an MP3 player (e.g., iPOD®), CD player, game console (e.g., XBOX®), or a DVD player. The invention is not limited to the specifically mentioned portable electronic devices, but may include any electronic device to which a user may wish to apply the conformable labels described herein.

In one embodiment, the sheet having a printable surface comprises an ink receptive layer overlying a conformable film.

In another embodiment, the present invention relates to a system for providing a decorative label for application to a portable electronic device, including:
a computer system including a display device, an input device, and a printer;
a source, available to the computer system, of a plurality of images displayable on the display device and printable on the printer;
a program installed and operable on the computer system capable of obtaining and displaying on the display device the plurality of images, selecting one or more of the plurality of images and printing with the printer the selected one or more image; and
a sheet having a printable front surface and an adhesive coated rear surface, the sheet being divisible into one or more conformable label, wherein the conformable label comprises a conformable film comprising a stress relaxation in the range from about 1 to about 12 Newtons, and being provided to the printer for printing;
in which the computer system with the program is operable via the input device to display the plurality of images on the display device, to select the selected one or more image, to align the selected one or more image on the sheet, to print the selected one or more image on the sheet, and to provide to a user the sheet with the printed image thereon, and
in which the user can remove one or more printed conformable label from the sheet and apply the printed conformable label conformably to a surface of the portable electronic device.

In yet another embodiment, the present invention relates to a method of providing a decorative label for application to a portable electronic device, including:
providing a source of a plurality of images;
providing a computer system having a display device, an input device, and a printer, the computer system programmed to obtain from the source, display on the display device, select with the input device one on more of the plurality of images and print with the printer the selected one or more image;
providing a sheet having a printable front surface and an adhesive coated rear surface, the sheet being divisible into one or more conformable label, wherein the conformable label comprises a conformable film comprising a stress relaxation in the range from about 1 to about 12 Newtons, and being provided to the printer for printing;
operating the computer system with the input device to obtain from the source the plurality of images, to display the plurality of images on the display device, to select one or more image from the plurality of images, to align the selected one or more image with a selected one or more conformable label, to print the selected one or more image on the selected one or more conformable label, and to provide to a user the sheet with the printed one or more conformable label, and
removing the printed one or more conformable label from the sheet and applying the printed one or more conformable label conformably to a surface of the portable electronic device.

In another embodiment, the invention relates to a decorated substrate including a substrate having a surface, the surface comprising a discontinuity; a decorative printed conformable label having an upper surface and a lower surface, wherein the conformable label comprises a conformable film comprising a stress relaxation in the range from about 1 to about 12 Newtons, wherein the lower surface is decoratively applied to the surface of the substrate, wherein the upper surface comprises a printable layer and the lower surface comprises an adhesive coating, the adhesive conformably adhering the label to the substrate, and wherein the printable layer comprises a decorative design printed thereon.

In another embodiment, the invention relates to a printed conformable label for application to a substrate, the label including a printable layer disposed on a first side of a conformable film, wherein the conformable film comprises a stress relaxation in the range from about 1 to about 12 Newtons, wherein the conformable film comprises an adhesive layer applied to a second side thereof, wherein the conformable label comformably adheres via the adhesive layer to a surface of a substrate, the surface including surface discontinuities to which the conformable label is desired to conform, the conformable label conformably remaining adhered to the surface and surface discontinuties for a period of about 10 days or more following application when stored at room temperature.

Thus, in accordance with the present invention, a method and system are provided in which an individual user can use his or her own home computer and printer to custom-print decorative, conformable labels and thereby customize the user's portable electronic devices with any of many available images, and may easily and at very little cost change from one decorative label to another at the whim of the user. The conformable labels may be easily applied to conform to uneven, rough or discontinuous surfaces of the user's portable electronic device.

### BRIEF DESCRIPTION OF THE DRAWINGS

FIG. 1 is a schematic perspective sectional view of an embodiment of a conformable in accordance with the present invention.

FIG. 2 is a schematic perspective sectional view of another embodiment of a conformable in accordance with the present invention.

FIG. 2A is a schematic perspective sectional view of another embodiment of a conformable in accordance with the present invention, similar to that of FIG. 2, but also including an additional layer.

FIG. 3 is a schematic perspective sectional view of a sheet including a plurality of pre-cut conformable labels, in accordance with an embodiment of the present invention.

FIG. 4 is a schematic perspective view of a system for carrying out the method of one embodiment of the present invention.

FIGS. 5-7 are schematic depictions of the display of a system such as that shown in FIG. 4 during steps of a process in accordance with an embodiment of the present invention.

FIGS. 8A and 8B are schematic depictions of the front surface and rear surface of a cell phone, including a decorative conformable label applied to the rear surface thereof, in accordance with an embodiment of the present invention.

FIGS. 9-14 are schematic cross-sectional views of the cell phone of FIGS. 8A and 8B, taken at line 9-14—9-14 of FIG. 8A, depicting a decorative conformable label applied to the rear surface of the cell phone, in accordance with several embodiments of the present invention.

FIG. 15 is a schematic depiction of a cell phone in which an electronic copy of an image has been provided to the cell phone for display as a wallpaper in the cell phone display area.

It should be appreciated that for simplicity and clarity of illustration, elements shown in the Figures have not necessarily been drawn to scale. For example, the dimensions of some of the elements, such as layer thickness, may be exaggerated relative to each other for clarity. Further, where considered appropriate, reference numerals have been repeated or are similar among the Figures to indicate corresponding elements.

It should be appreciated that the process steps and structures described below may not form a complete process flow for preparing particular decorative labels for a portable electronic device. The present invention can be practiced in conjunction with processing methods and fabrication techniques currently used in the art, and only so much of the commonly practiced process steps and known devices and systems are included as are necessary for an understanding of the present invention.

### DETAILED DESCRIPTION

The terms “over” and “overlies” and cognate terms such as “overlying” and the like, when referring to the relationship of one or a first layer relative to another or a second layer, refers to the fact that the first layer partially or completely lies over the second layer. The first layer overlying the second layer may or may not be in contact with the second layer. For example, one or more additional layers may be positioned between the first layer and the second layer. The terms “under” and “underlies” and cognate terms such as “underlying” and the like have similar meanings except that the first layer partially or completely lies under, rather than over, the second layer.

The term “between” when referring to the position of a first layer relative to the position of a second layer and a third layer, refers to the fact that the second layer and third layer are on opposite sides of the first layer. The first layer may or may not be in contact with the second layer or the third layer. For example, one or more additional layers may be positioned between the first layer and the second layer or between the first layer and the third layer.

The term “transparent” when referring to a transparent film layer overlying a layer of the inventive multilayer film means that the underlying layer can be seen through the transparent film layer. The transparent film layer may be translucent.

The terms “upper” and “lower” are sometimes used in the specification and the appended claims to refer to the relative position of a layer or a surface of a layer used in the inventive multilayer film. These terms refer to relative positions as illustrated in the drawings. While it is recognized that the multilayer films illustrated in the drawings could be tilted sideways or upside down and as such an upper or lower layer or surface would not technically be an “upper” or “lower” layer or surface, it is to be understood that in determining whether a multilayer film has an upper or lower layer or surface, the multilayer film is to be oriented as illustrated in the drawings.

In one embodiment, the present invention relates to a method of personalizing a portable electronic device, including steps of providing a portable electronic device having a front surface and a rear surface; providing a sheet having a printable front surface and an adhesive coated rear surface, the sheet being divisible into one or more conformable label; providing in electronic format a plurality of images printable by a printer; selecting one or more image for printing from the plurality of images; printing the selected one or more image on the printable surface of one of the one or more conformable label; separating the printed conformable label from the sheet; and conformably applying the printed conformable label to a surface of the portable electronic device. In one embodiment, the conformable label is divisible by being pre-cut into conformable labels having a predetermined size.

The following description refers in some embodiments to an exemplary method and system in which the conformable label is applied to the rear surface of the portable electronic device. This is for illustrative purposes only, and it is understood that the conformable label may be applied to any appropriate surface of the portable electronic device. In one embodiment, the conformable label is not intended to be applied over user-activated portions, such as keys, push-buttons and/or receptacles on the surfaces of the portable electronic device.

In carrying out the method in accordance with this embodiment of the present invention, the user first provides a substrate, such as a portable electronic device, that the user wishes to customize. In one embodiment, the portable electronic device may be, for example, a telephone or telephone handset, a cellular telephone, a radio telephone, a walkie-talkie, a personal digital assistant, a digital camera, an MP3 player (e.g., iPOD®), a handheld, notebook or desktop computer, CD player, game console (e.g., XBOX®), or a DVD player. The substrate may include other electronic devices, such as a computer mouse, a joystick, a remote control for a stationary electronic device (such as a television or stereo receiver or amplifier), or any other electronic device that a user may desire to personalize with a conformable label in accordance with the present invention. The invention is not limited to the specifically mentioned portable electronic devices, but may include any electronic device to which a user may wish to apply the conformable labels described herein, including subsequently (future) developed portable electronic devices.

In one embodiment, the substrate has a surface that includes one or more discontinuity to which the conformable label needs to and does conform. For example, the rear surface of portable electronic devices commonly includes discontinuities such as ridges, depressions, embossed or debossed printing, and other such irregularities. In accordance with the present invention, the conformable label is able to substantially conform to the outlines of such discontinuities, so that in one embodiment, the conformable label may be applied without significant bridging, creasing or folding of the label. Thus, in one embodiment, when applied to the rear surface, the conformable label conforms to the rear surface substantially without creases or folds. Of course, it will be recognized that, in the case of fine embossed and/or debossed letters, numbers and similar indicia, the conformable label, when applied, may bridge over some portions of such indicia. However, the conformable label nevertheless substantially conforms to the surface.

In one embodiment, the conformable label in accordance with the present invention includes a conformable film having a thickness in the range from about 25 microns up to about 500 microns, and in one embodiment from about 50 microns to about 250 microns, and in another embodiment from about 60 microns to about 150 microns. In one embodiment, when a conformable label in accordance with the present invention has a thickness in this range, the label is able to conform to discontinuities having an offset from one surface to an adjacent surface ranging up to about 3000 microns (3 mm). In one when a conformable label in accordance with the present invention has a thickness in this range, the label is able to conform to discontinuities having a radius of curvature at the offset as small as about 0.5 microns, and in one embodiment, about 1 micron.

Here and elsewhere in the specification and claims, the range and ratio limits may be combined. That is, for example, in the foregoing ranges, although a range from 25 to 250 microns is not explicitly stated, such is deemed to be within the scope of this disclosure. In addition, intervening integral values are deemed to be included within the disclosed ranges in the specification and claims. In one embodiment, the substrate has discontinuities having dimensions, such as height or displacement, greater than the thickness of the conformable printed label.

The conformable label provided in accordance with the present invention is intended to be adhered either to the front, side or rear surface of the portable electronic device.

In one embodiment, the conformable label is provided in a sheet having a front surface and a rear surface, with an adhesive coating on the rear surface. In such an embodiment, the label is generally printed on the front surface, and the adhesive-coated rear surface is applied to the appropriate surface of the portable electronic device. In one embodiment, a carrier sheet overlies the adhesive coated rear surface. In one such embodiment, the carrier sheet is release-coated. The adhesive coating of the conformable labels can be protected by the carrier sheet/release liner, which is releasably adhered to the adhesive. Silicone treated paper is an example of a useful release liner. Any suitable release liner can be used that is compatible with the adhesive employed.

The adhesive coating may comprise pressure sensitive adhesives or heat activated adhesives which are well known to those skilled in the art.

The user provides, or obtains from a commercial source, the sheet having a printable front surface and an adhesive coated rear surface. As noted, in one embodiment, the sheet is divisible into smaller elements which can be used as conformable labels within the scope of the invention. In one embodiment, the sheet is provided with pre-cut shapes, e.g., by die cutting the sheet to form a plurality of individual labels having into various pre-cut shapes and sizes. The pre-cut shapes can be customized for individual portable electronic devices. For example, the user can be provided with a sheet having pre-cut labels appropriate to the particular portable electronic device that the user intends to customize, and may include a variety of different shapes and sizes corresponding to various portable electronic devices.

When the user has the sheet and the portable electronic device, the user is provided with, or the user provides for him- or herself, and the user can then refer to, a plurality of images which are in electronic format and which can be printed by a printer. Suitable printers include, for example, inkjet printers, dye sublimation printers, thermal transfer printers, laser printers, and any other known printer capable of printing such labels. In general, such images will be displayed on the display of a personal computer. In one embodiment, the personal computer is the user's own machine, e.g., in the user's home or office, while in other embodiments, the personal computer may be at some other location, such as a kiosk in a mall or other commercial location. In any event, the personal computer should be equipped with an input device, such as a mouse and/or a keyboard, a display device, such as a monitor, and a source of the plurality of images in electronic format. Such sources, may include, for example, one or more of an internet site, a digital camera, a magnetic data storage medium, such as a floppy disk, an optical data storage medium, such as a CD-ROM, CD-RW or a DVD, and a scanner attached to the user's computer. This list of possible sources is not intended to be exhaustive or limiting, but exemplary of the many possible sources for such images.

When the user has been provided or has obtained the plurality of images, the user can then select from the available images an image for printing. The selection may be accomplished in any known manner, such as by clicking on a selected icon or image displayed on a computer monitor.

In one embodiment, the user uses the personal computer to adjust the size of the selected image for printing to fit the predetermined size of the label. This adjustment may take place for example, by displaying both the selected image and a copy or outline of the pre-cut conformable label on the display device, and aligning the images on the display device, and adjusting the size of the selected image to match the size of the pre-cut conformable label. In another embodiment, the user may align the selected image within the shape of the pre-cut conformable label in a desired orientation. In an embodiment in which the sheet is not pre-cut, the user may select any appropriate orientation of the selected one or more image. The user can later cut out the selected image by hand or by use of, e.g., a suitable cutting device having a predetermined shape and size.

When the user has selected the image for printing and made any needed adjustments, the user next can print the selected image on the printable surface of the pre-cut conformable label. In one embodiment, the printing is inkjet printing and the printable surface is an inkjet printable surface. In other embodiments, the printing may be by, e.g., dye sublimation printing, thermal transfer printing, and laser printing. However, it is more common, for example, for home users, to have available an inkjet printer. Thus, it is contemplated that in most cases, the printing will be by inkjet printing.

Following the printing, the user can separate the printed conformable label from the sheet, and then apply the conformable label to a selected surface, i.e., front, side or rear surface, of the portable electronic device.

In one embodiment, the user subsequently removes the printed label from the device and replaces the removed label with another label printed with another of the plurality of images, by repeating the steps of the method just described.

As described above, the sheet provided is divisible, and may be pre-cut to provide a plurality of conformable labels. A conformable label in accordance with this invention is defined, in one embodiment, as comprising a film having an elongation of about 100% or greater. In another embodiment, a conformable label comprises a film having an elongation at break of about 100% or greater and a stress relaxation in the range from about 1 Newton to about 12 Newtons, in one embodiment, from about 1.5 Newtons to about 8 Newtons, in one embodiment, from about 2 Newtons to about 6 Newtons, and in yet another embodiment, from about 2.5 Newtons to about 4 Newtons. In some embodiments, the elongation at break may be about 150% or greater, and in another embodiment, about 200% or greater, and in yet another embodiment, the elongation at break is in a range from about 200% to about 350%, each with ranges of stress relaxation comparable to the above ranges.

In another embodiment, “conformability” (and cognate terms) means the conformable label has the ability to yield to the contours or discontinuities of a discontinuous, curved or rough surface without formation of creases or folds, and in one embodiment, also without bridging over such surface contours or discontinuities. When using a label that is not conformable, problems may be encountered in respect to rigid substrates such as provided by the portable electronic devices to which the labels of the present invention are applied. Films are not fully acceptable for such applications if the films are not sufficiently conformable to prevent bridging of surface depressions that result from the shape and form of the portable electronic devices. Such bridging results in actual or apparent air bubbles which greatly detract from the appearance of the label.

In one embodiment, the sheet provided has the printable surface which includes an ink receptive layer overlying a conformable film. Additional details relating to the ink receptive layer are set forth below.

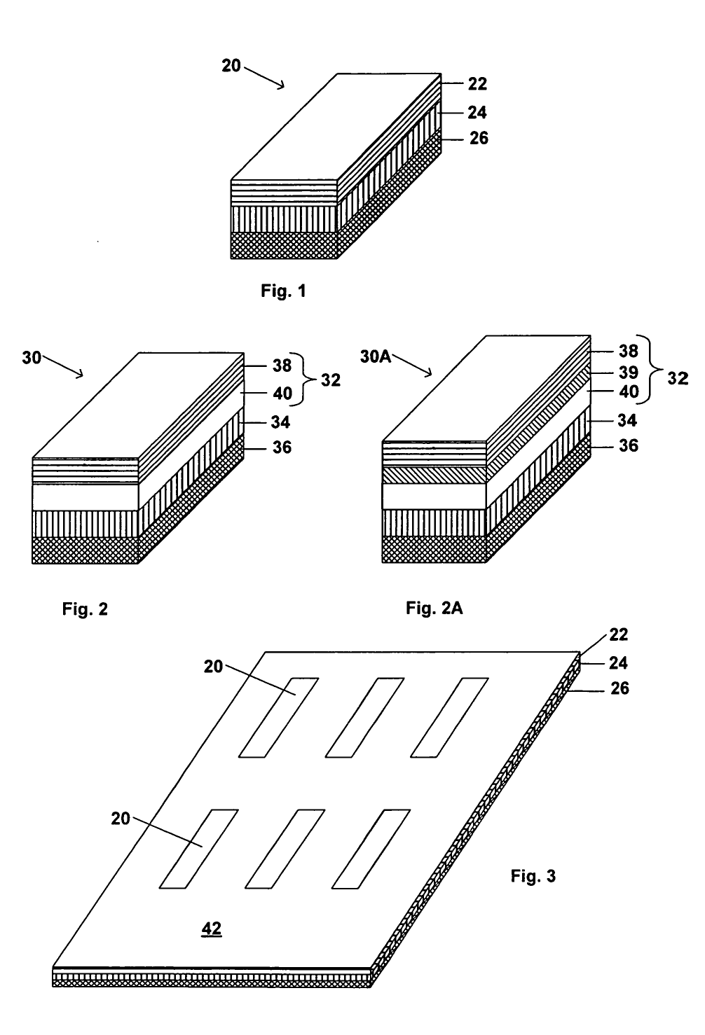

Three embodiments of a conformable label that can be prepared in accordance with the present invention are shown in FIGS. 1, 2 and 2A.

FIG. 1 is a schematic perspective sectional view of an embodiment of a conformable label 20 in accordance with the present invention. The conformable label 20 includes a conformable layer 22, an adhesive layer 24 and a release liner 26. In this embodiment, the conformable layer 22 is shown as a single layer, in which the layer 22 is both ink receptive and conformable. Although not shown in FIG. 1, additional layers may be included, such as a primer layer or a tie layer, between any of the layers.

FIG. 2 is a schematic perspective sectional view of another embodiment of a conformable label 30 in accordance with the present invention. The conformable label 30 includes a conformable layer 32, an adhesive layer 34 and a release liner 36. In this embodiment, the conformable layer 32 is shown as a double layer, in which the layer 32 includes separate ink receptive layer 38 and conformable film 40, which together form the conformable layer 32. Although not shown in FIG. 2, additional layers may be included, such as a primer layer or a tie layer, between any of the layers.

FIG. 2A is a schematic perspective sectional view of another embodiment of a conformable in accordance with the present invention, similar to that of FIG. 2, but also including a tie or primer layer 39 between the ink receptive layer 38 and the conformable film 40. In this embodiment, the tie or primer layer 39, together with the ink receptive layer 38 and the conformable film 40, form the conformable layer 32. The tie or primer layer 39 may be any suitable tie or primer layer known in the art. In the disclosure below, examples of same are provided. The tie or primer layer 39 may be used to obtain improved anchorage between the ink receptive layer 38 and the conformable film 40. In some combinations of ink receptive layer materials and conformable film materials, the anchorage or bonding together of these two layers may be less than desirable, in which case a suitable tie layer or primer layer can be used between these layers to obtain the improved anchorage. Where, for example, the conformable film comprises a plurality of layers, suitable tie or primer layers can be located between such layers, and such suitable tie or primer layers can also be located between the conformable film and the adhesive layer.

FIG. 3 is a schematic perspective sectional view of a sheet 42 including a plurality of pre-cut conformable labels 20, similar to the conformable labels 20 described with respect to FIG. 1. In other embodiments, the pre-cut labels in the sheet including a plurality of such pre-cut labels may contain the conformable labels 30 rather than the labels 20, and in other embodiments, may include other embodiments of pre-cut conformable labels. In FIG. 3, the sheet 42 includes six conformable labels 20 arranged as shown, but in other embodiments, such sheet may include a higher or lower number of pre-cut conformable labels, the labels may be of different sizes and the labels may be arranged differently on the sheet. FIG. 3 is intended to be exemplary, and is not limiting of the invention.

Exemplary Conformable Films

In one embodiment, the printable conformable layer is a conformable polymeric material which is treated by corona or another known surface-preparation treatment to increase its printability.

In one embodiment, the printable conformable label comprises a multilayered thermoplastic film such as that described in U.S. Pat. No. 6,770,360, the disclosure of which relating to such films is incorporated herein by reference. In one embodiment, the printable conformable label comprises a multilayered thermoplastic film including a thermoplastic core layer having a first side and a second side, the core layer including (a) a polyolefin having a density in the range of about 0.89 to about 0.97 grams per cubic centimeter; and (b) from about 2% to about 25% by weight of a second polymeric material selected from ionomers derived from sodium, lithium or zinc and an ethylene/unsaturated carboxylic acid copolymer. In one embodiment, the core layer further includes (c) a light stabilizer which, in one embodiment, is present at a concentration of about 1000 to about 10,000 ppm based on the weight of the core layer. The light stabilizer is generally used in embodiments that are expected to sustain extended exposure to sunlight, so the light stabilizer may not be needed in the present invention. In addition to the core layer, the multilayered thermoplastic film of this embodiment further includes at least one abrasion resistant first thermoplastic skin layer overlying the first side of the core layer; and at least one second thermoplastic skin layer overlying the second side of the core layer. In addition, the multilayered film includes at least one layer of a pressure sensitive adhesive overlying the second thermoplastic skin layer. In general, the composition of the core layer is different from the composition of the skin layers, and the core layer and the skin layers are characterized by the absence of PVC.

In one embodiment of the multilayered thermoplastic film, the core comprises from about 2% to about 10% by weight of the second polymeric material.

In one embodiment of the multilayered thermoplastic film, the core layer further includes from about 1% to about 45% by weight of a third polymeric material selected from ethylene/vinyl acetate copolymers, acid modified ethylene/vinyl acetate copolymers, anhydride modified ethylene/vinyl acetate copolymers, acrylate modified ethylene/vinyl acetate copolymers, anhydride modified polyolefins, acid modified ethylene acrylate polymers and anhydride modified ethylene acrylate polymers. In one embodiment, the core includes from about 20% to about 40% by weight of the third polymeric material. In one embodiment, the third polymeric material is an ethylene/vinyl acetate copolymer.

In one embodiment, the multilayered thermoplastic film further comprises a clear topcoat layer which overlies the first thermoplastic skin layer, wherein the clear topcoat layer is characterized by the absence of PVC.

In one embodiment of the multilayered thermoplastic film, a release liner overlies the layer of pressure sensitive adhesive.

In one embodiment, the multilayered thermoplastic film further includes an opacifying layer between the core layer and the second skin layer. In one embodiment, the opacifying layer comprise a white pigment, a black pigment or a mixture thereof.

In one embodiment of the multilayered thermoplastic film, the first skin layer is comprised of an ionomer derived from sodium, lithium or zinc and an ethylene/unsaturated carboxylic acid copolymer. In one embodiment, the skin layer including the ionomer results in improved adhesion between an overlying ink receptive layer and the multilayered film. Ionomers (polyolefins containing ionic bonding of molecular chains) also are useful. Examples of ionomers include ionomeric ethylene copolymers such as SURLYN® 1706 (duPont) which is believed to contain interchain ionic bonds based on a zinc salt of ethylene methacrylic acid copolymer. SURLYN® 1702 from duPont also is a useful ionomer.

As noted, in one embodiment, the core layer includes a combination of thermoplastic polymers. This combination may include a polyolefin having a density in the range of about 0.89 to about 0.97 g/cc, and in one embodiment about 0.915 to about 0.97 g/cc, and in one embodiment about 0.926 to about 0.945 g/cc. In one embodiment, the core includes the second thermoplastic polymeric material selected from ethylene-unsaturated carboxylic acid or anhydride such as ethylene-acrylic acid copolymers, or ethylene-methacrylic acid copolymers, ionomers derived from sodium, lithium or zinc and ethylene-unsaturated carboxylic acid or anhydride such as ethylene/methacrylic acid copolymers, and combinations of two or more thereof. The concentration of the second thermoplastic polymeric material may be in the range of about 2% to about 25% by weight based on the weight of the core layer 16. In one embodiment, the concentration of the second thermoplastic polymer is from about 2% to about 22% by weight, and in one embodiment about 3% to about 20% by weight, and in one embodiment about 3% to about 10% by weight based on the weight of the core layer 16. The combined weight of the polyolefin and second thermoplastic polymeric material is at least about 60% by weight based on the weight of the core layer 16, and in one embodiment about 60% to about 95% by weight, and in one embodiment about 70% to about 95% by weight based on the weight of the core layer.

The polyolefins that are useful in the core include polyethylene, polypropylene or polybutylene or copolymers of ethylene, propylene or butylene with an alpha olefin. The alpha olefin, is selected from those alpha olefins containing from 3 to about 18 carbon atoms, and in one embodiment 2 to about 12 carbon atoms, and in one embodiment, 3 to about 8 carbon atoms, including propylene, ethylene, butene, butylene, hexene, 4-methylpentene and octene. The polyolefin core may be made by a blend of polyolefins such as a polyethylene and an ethylene propylene copolymer. Medium density polyethylenes and the linear medium density polyethylenes are useful. Useful polyolefins include those prepared using a Ziegler-Natta catalyst or a metallocene catalyst. An example of a useful polyolefin is available from Huntsman Products under the trade designation 1080, which is identified as a polyethylene having a density of 0.93 g/cc. Affinity 1030HF, which is a product of Dow Chemical identified as a metallocene catalyst catalyzed octene-ethylene copolymer can also be used. Dowlex 2036A which is a product of Dow identified as linear medium density polyethylene can be used. Quantum 285-003, which is a product of Millenium Petrochemical identified as a polyethylene resin having a density of 0.93 grams per cubic centimeter can be used.

As described above, in one embodiment, the core layer may include a second thermoplastic material selected from ethylene-unsaturated carboxylic acid or anhydride copolymers, ionomers derived from sodium, lithium or zinc and ethylene/unsaturated carboxylic acid or anhydride copolymers, and combinations of two or more thereof. The ionomer resins available from DuPont under the tradename SURLYN® can be used. These resins are identified as being derived from sodium, lithium or zinc and copolymers of ethylene and methacrylic acid. Included in this group are: the sodium containing ionomers available under the SURLYN® name and the following designations: 1601, 1605, 1707, 1802, 1901, AD-8548, 8020, 8140, 8528, 8550, 8660, 8920 and 8940. Also included are the zinc containing ionomers available under the SURLYN® name and following designations: 1650, 1652, 1702, 1705-1, 1855, 1857, AD-8547, 9120, 9650, 9730, 9910, 9950 and 9970. The lithium containing ionomers available under the SURLYN® name and the following designations are also useful: AD-8546, 7930 and 7940.

The ethylene/methacrylic acid copolymers that are useful include those available from DuPont under the tradename NUCREL®. These include NUCREL® 0407, which has a methacrylic acid content of 4% by weight and a melting point of 109° C., and NUCREL® 0910, which has a methacrylic acid content of 8.7% by weight and a melting point of 100° C.

The ethylene/acrylic acid copolymers that are useful include those available from Dow Chemical under the tradename PRIMACOR®. These include PRIMACOR® 1430, which has an acrylic acid monomer content of 9.5% by weight and a melting point of 97° C.

In one embodiment, the printable conformable label comprises a calendered or uncalendered vinyl halide film including (A) at least one vinyl halide polymer, (B) at least one non-halogenated polymeric plasticizer and (C) at least one second plasticizer different from the non-halogenated polymeric plasticizer, in which a major amount of the polymers of the film comprise the vinyl halide polymer (A) and wherein the film has an elongation at break of about 50% or greater.

In one embodiment, the vinyl halide film has a thickness from about 25 to about 500 microns, or from about 40 to about 250 microns, or from 40 to about 150 microns.

In one embodiment, the vinyl halide film has an elongation at break of about 50% or greater, about 55% or greater, about 65% or greater, or about 75% or greater.

In one embodiment, the vinyl halide film includes at least one vinyl halide polymer. In one embodiment, the vinyl halide polymer is present as a major amount of the polymers present in the film. In one embodiment, the vinyl halide polymers include homopolymers or copolymers of vinyl chloride. In one embodiment, the vinyl halide films include those derived from vinyl bromide, vinyl chloride or vinyl fluoride. Examples of these films include polyvinyl chloride and polyvinyl fluoride films. The polyvinyl chloride resins (sometimes referred to herein as PVC resins) are well known and include both homopolymers of vinyl chloride and copolymers of vinyl chloride with a minor amount by weight of one or more ethylenically-unsaturated comonomers that are copolymerizable with the vinyl chloride. Examples of such ethylenically-unsaturated comonomers include vinyl halides such as vinyl fluoride and vinyl bromide; alpha-olefins such as ethylene, propylene and butylene; vinyl esters such as vinyl acetate, vinyl propionate, vinyl butyrate and vinyl hexanoate, or partially hydrolyzed products thereof such as vinyl alcohol; vinyl ethers such as methyl vinyl ether, propyl vinyl ether and butyl vinyl ether; acrylic esters such as methyl acrylate, ethyl acrylate, methyl methacrylate and butyl methacrylate and other monomers such as acrylonitrile, vinylidene chloride and dibutyl maleate. Such resins are generally known and many are commercially available. In one embodiment, the vinyl film is a homopolymer of vinyl chloride. Examples of polyvinylchloride resins that are commercially available include GEON® polyvinyl chlorides available from BF Goodrich Company, POLYVIN polyvinyl chlorides available from A. Schulman, and UNICHEM polyvinyl chlorides available from Colorite Plastics.

In one embodiment, the polyvinyl chlorides have a K-value of from about 50 to about 90, or from about 55 to about 85, or from about 60 to about 82. The polyvinyl chlorides, in another embodiment, have an inherent viscosity (ASTM D-1243-60-A) of from about 0.8 to about 1.8, or from about 0.9 to about 1.5, or from about 1 to about 1.3. In another embodiment, the polyvinyl chlorides have a specific gravity of about 0.9 to about 1.8, or from about 1.2 to about 1.6. In another embodiment, the number average molecular weight of the PVC resins useful in the present invention range from about 20,000 up to about 80,000, and in another embodiment, from about 40,000 to about 60,000.

In one embodiment, the vinyl halide film contains at least two plasticizers. One plasticizer is (B) a non-halogenated polymeric plasticizer. The other plasticizer is (C) a second plasticizer. A combination of non-halogenated plasticizers and second plasticizers may be used. For example, the calendered vinyl film may contain two non-halogenated plasticizers and a second plasticizer. The total plasticizer content typically contains up to 50% of the non-halogenated plasticizer(s). Typically, the non-halogenated plasticizer is present in an amount of less than about 30%, or less that about 20% or less than 15% of the total amount of the plasticizers in the film. In one embodiment, the non-halogenated plasticizer is present in an amount of less than 5%, or less that 4% of the total plasticizers in the film.

The non-halogenated polymeric plasticizer (B) may be a single polymer or a combination of two or more polymers. The non-halogenated polymeric plasticizer is present in an amount of less than about 20 parts per hundred parts of the vinyl halide polymer (A). Generally, the non-halogenated polymeric plasticizer is present in an amount from about 0.5 to about 18, or from 1 to about 15, or from about 1.5 to about 8 parts per hundred parts of the vinyl halide polymer (A). The non-halogenated plasticizers are those polymers that provide plasticizing properties to the composition. In one embodiment, the non-halogenated plasticizers are those having a T_{g} of −18° C. or below. In one embodiment, the non-halogenated plasticizers have a T_{g} of −20° C., or −25° C., or −30° C., or below. In one embodiment, the non-halogenated polymeric plasticizers are liquid.

In one embodiment, the non-halogenated polymeric plasticizer (B) is a natural or synthetic thermoplastic elastomer, including synthetic or natural rubbers. Various thermoplastic elastomers can be utilized. Commercially available thermoplastic elastomers (TPE) are either block copolymers (e.g., styrenics, copolyesters, polyurethanes and polyamides) or elastomer/thermoplastic compositions such as thermoplastic elastomeric olefins (TEO) and thermoplastic vulcanizates (TPV).

In one embodiment, the halogen containing film includes a second plasticizer. The second plasticizer (C) is typically present in an amount greater that about 80 parts per hundred parts of the vinyl halide polymer (A). Generally, the second plasticizer is present in an amount from about 80 to about 99.5, or from 85 to about 99, or from about 92 to about 98.5 parts per hundred parts of the total plasticizer content.

Suitable plasticizers for use as plasticizers (B) and (C) are disclosed in U.S. Published Patent Application No. 2004/0039106, the disclosure of which is incorporated by reference for its teachings relating to plasticizers.

In one embodiment, the second plasticizer is a polymeric plasticizer different from the non-halogenated polymeric plasticizer.

The vinyl halide film may contain fillers such as pigments for color and strength as well as additives to protect against oxidation and ultraviolet radiation. Inorganic fillers may be included in the core to provide opaque films. Useful fillers include calcium carbonate, titanium dioxide and blends thereof.

In one embodiment in which the vinyl halide film is calendered, the vinyl halide film is prepared on a L-type calender. A calendering process for making the vinyl halide film in accordance with this embodiment is disclosed in the aforementioned U.S. Published Patent Application No. 2004/0039106, the disclosure of which relating to vinyl halide films is incorporated herein by reference. The apparatus used in this process includes a co-kneader, a 2-roll mill, a calendering section, and a tempering unit. The dry-blend of raw materials is fed from a hopper to a co-kneader where the dry-blend is homogenized at a temperature of approximately 175° C. The homogeneous half-molten plastic is fed to a 2-roll mill, where further homogenization takes place at a temperature of 170° C. From the 2-roll mill, the melt is fed to the calender section, where the plastic film is formed by means of a number of steel cylinders. During this step the temperatures vary between 170° C. and 200° C. After the calender section, the film is moved through a tempering unit to cool it down and remove any stress from the film. The average running speed depends on the film thickness, film width and equipment used, and can vary between 80 to 120 meters per minute in the case of a 70 micrometers thick film.

### EXAMPLE 1

The following formulation of a vinyl halide polymeric material was fed into a hopper for extrusion coating followed by calendering to produce the resulting film.

| Ingredients | Parts |
|---|---|
| PVC (K-64) | 65 |
| PVC (K-58) | 35 |
| ethylene, vinyl acetate, carbon monoxide | 2 |
| terpolymer, Elvaloy 742 (DuPont) | |
| adipic polymer plasticizer, Palamoll 652 (BASF) | 30 |
| Benzophenone UV absorber | 3 |
| barium zinc thermal stabilizer, Baerostab BZ 8780 | 3 |
| Acrylic processing aid, Paraloid K125 (PMMA) | 2 |

Additional examples of the vinyl halide film include the following:

### EXAMPLE 2

A film is prepared by adding 64 parts of Solvesso 100 into a vessel. A Cowles mixer is stirring at 500 rpm and 14 parts of nitrile rubber (Nipol 1312LV) is added to the vessel. When the rubber is dissolved, 3 parts of heat stabilizer (Baerostab BZ8780) and 0.75 parts of UV absorber (Chimassorb 81) are added to the vessel. Next, 35 parts of plasticizer (Palamoll 656) and 100 parts of a polyvinylchloride having an inherent viscosity of 1.22 and a K-value of 78 is slowly added to the vessel and the mixing continued for about 30 minutes. Temperature of the materials is maintained at or below 28° C. The mixing is continued until the mixture which is now a dispersion, has a maximum PVC particle size of less than 10 microns (measured with Hegman grind meter). The PVC dispersion is filtered over a 25 micron filter and 55 parts of colorant (Kronos 2220) is added to the vessel. The dispersion is stirred for 1 minute and filtered under vacuum over a 10 micron filter. The dispersion is now in the form of a paste. Depending on color and way of production the viscosity can be adjusted by addition of some solvent. The vacuum is necessary to remove the air from the paste. This paste is ready for use on the coater to make a PVC film.

### EXAMPLES 3-8

Following the procedure of Example 2, the following table contains the materials added to form the PVC dispersion.

| | Example | | | | | |
|---|---|---|---|---|---|---|
| | 3 | 4 | 5 | 6 | 7 | 8 |
| PVC of Ex 2 | 100 | 100 | 100 | 100 | 100 | 100 |
| Nitrile rubber | 14.5 | 14 | 5 | 10 | 15 | 20 |
| of Ex 2 | | | | | | |
| Plasticizer | 16 | 16 | 16 | 16 | 16 | 16 |
| of Ex 2 | | | | | | |
| Colorant of | 55 | 53 | 43.5 | 43.5 | 43.5 | 43.5 |
| Ex 2 | | | | | | |
| Heat stabilizer | 3 | 3 | 3 | 3 | 3 | 3 |
| of Ex 2 | | | | | | |
| UV stabilizer | 0.75 | 0.75 | 0.75 | 0.75 | 0.75 | 0.75 |
| of Ex 2 | | | | | | |
| Solvent of Ex 2 | 63.7 | 53 | 53 | 53 | 53 | 53 |

The above PVC pastes are ready for coating to form the PVC film. Two coating techniques may be used: Knife Over Roll (KOR) and Reverse Roll (RR). The choice for one of these two techniques depends on film thickness, quantity, paste viscosity and film quality. White films will be coated with the Reverse Roll system since white is produced in larger quantities. A silicone-free release paper is used as a substrate for coating. The paste is applied to the release paper and placed in an oven. In this oven the solvent is evaporated and the PVC particles fuse. The result is a dry vinyl film on a casting paper.

The foregoing conformable film may have an ink receptive layer applied thereover to form the sheet having a printable surface in accordance with the present invention. Suitable ink receptive layer materials are disclosed in detail below.

In one embodiment, the sheet having a printable surface includes an ink receptive layer overlying a conformable film. Details on several embodiments of ink receptive layer are described following descriptions of additional exemplary conformable layers materials.

In one embodiment, the conformable film is prepared from an aqueous film-forming mixture comprising, based on the weight of the solids, (A) from about 50% to about 80% by weight an acrylic-urethane copolymer which forms a film having an elongation at break in the range from about 100% to about 300% or greater, and (B) from about 5% to about 25% by weight of an acrylic polymer or copolymer having a T_{g} of less than about 55° C., wherein the acrylic polymer or copolymer (B) is different from the acrylic-urethane copolymer (A).

The major component of the aqueous film-forming mixture of this embodiment is an acrylic-urethane copolymer (i.e., a polymer containing urethane moieties (—R¹NHC(O)OR^{2+L) — and (meth)acrylic moieties (—CH—C(R}³)CO₂R⁴). This copolymer may be present in the aqueous mixture in an amount of from about 50% to about 80% by weight, based on the total weight of solids in the aqueous mixture. In other embodiments, the acrylic-urethane copolymer is present in amounts of from about 55% to about 75%, and in another embodiment, in an amount from about 60% to about 70% by weight, based on the total weight of solids in the aqueous mixture. Suitable acrylic-urethane copolymers in the aqueous mixtures of the present invention are those copolymers which form a film having an elongation at break in the range from about 100% to about 300% or greater. That is, the copolymer itself forms a film having this elongation at break. In other embodiments, the acrylic-urethane copolymer utilized in the aqueous mixture is one which forms a film having an elongation at break of about 400% greater or even about 500% or greater.

Suitable acrylic-urethane copolymers for use in the aqueous mixtures of this embodiment also are those which also are capable of forming stable dispersions in water. In one embodiment, the acrylic-urethane copolymers are aliphatic acrylic-urethane copolymers with acid numbers of from about 15-16. Acrylic-urethane copolymers useful in the aqueous mixtures of the present invention are available commercially from a variety of sources. For example, a useful acrylic-urethane copolymer is commercially available under the trade designation “NeoPac®) R-9000” from Zeneca Resins, Inc., Wilmington, Mass. This acrylic-urethane copolymer is a solvent-free aliphatic urethane acrylic copolymer. NeoPac® R9000 is available as an aqueous mixture containing 40% solids and 1.2% triethylamine as a stabilizer. A free film prepared from NeoPac® R9000 has an elongation at break of about 620%. The acid number of NeoPac® R9000, on solids, is 16. Other useful acrylic-urethane copolymers having the desired characteristics are known in the art. A number of aqueous dispersions of acrylic-urethane copolymers are described in EP Publication No. 0 424 705 and in WO 98/45347, the disclosures of which are incorporated herein by reference. Any of these copolymers which form films having an elongation at break of about 300% or greater can be used in the present invention.

The aqueous film-forming mixtures of this embodiment further contain (B) from about 5% to about 25% by weight of an acrylic polymer or copolymer having a T_{g} of less than about 55° C., based on the weight of the solids in the aqueous mixture. In another embodiment, the aqueous film-forming mixture comprises from about 7 to about 20% of the acrylic polymer or copolymer having a T_{g} of less than about 55° C. In yet another embodiment, the acrylic polymer or copolymer (B) utilized in the aqueous mixtures of the present invention is characterized as having a T_{g} of between about −15° to about 50° C.

The acrylic copolymers may be based on from 30% to 60% by weight of C₁-C₈ alkyl (meth)acrylate monomer, from 30% to 60% by weight of vinyl aromatic monomers and from 0.5% to 10% by weight of (meth)acrylic acid. The C₁-C₈ alkyl (meth)acrylate monomers may be linear or branched chain derivatives. Examples include methyl acrylate, methyl methacrylate, ethyl acrylate, ethyl methacrylate, n-propylacrylate, n-propyl methacrylate, isobutyl methacrylate, etc.

Examples of vinyl aromatic monomers present as monomer units in the acrylate copolymer include styrene, alkylstyrene and vinyltoluene.

The acrylate copolymer can be prepared by techniques known from the prior art, an example being emulsion polymerization. The acrylate polymer is usually employed in the form of a dispersion. During the preparation process, in one embodiment, the ratio between the monomers and the water is established such that the resultant dispersion has a solids content of from 30 to 60% by weight, in another embodiment from 35 to 60% by weight, and the dispersion can be used directly to prepare the aqueous mixture. Examples of commercially available dispersions of such copolymers wherein the vinyl aromatic monomer is styrene are ACRONAL® 290D (Europe) and ACRONAL® 296D (U.S.) from BASF AG.

A variety of acrylic polymers and copolymers having the desired T_{g} and which are useful in the aqueous mixtures of the present invention are available commercially. Examples of useful acrylic polymers and copolymers are listed in Table I.

TABLE I
Acrylic Polymers and Copolymers

| Trade Designation | | Source | % Solids | Type | T_{g}(° C.) |
|---|---|---|---|---|---|
| ACRONAL ® Optive | 100 | BASF | 50 | Acrylic | 18 |
| | 110 | BASF | 46 | Acrylic | 16 |
| | 296D | BASF | 50 | Styrene-Acrylic | 20 |
| | 300 | BASF | 50 | Acrylic | 2 |
| | 310 | BASF | 45 | Styrene-Acrylic | 38 |
| | 320 | BASF | 47 | Acrylic | 50 |
| Nacrylic | 2550 | National Starch | 50 | Acrylic | 22 |
| | CP3650 | National Starch | 45 | Acrylic | 50 |
| | 6408 | National Starch | 45 | Acrylic | 51 |
| | 6435 | National Starch | 40 | Acrylic | 35 |
| RHOPLEX ® | E2780 | Rohm & Haas | 48.5 | Acrylic | −10 |

The aqueous film-forming mixture used in this embodiment may include other additives such as pigments, fillers, flattening agents, light stabilizers, coupling agents, adhesion promoters, rheology control agents, surfactants, and the like, that are compatible with water-based systems. Any of these components can be used in various combinations, including two or more of each type of compound, to achieve desired results.

In one embodiment, the aqueous film-forming mixtures may contain from 0 to about 40% by weight, based on the total weight of solids in the aqueous mixture of a pigment. In other embodiments, the mixtures may contain from about 20% to about 40% or from about 25% to about 35% by weight of one or more pigments.

Pigments suitable for use in water-based systems are well known in the art Inorganic fillers and pigments can be included in the aqueous mixtures to provide opaque films. Useful pigments include calcium carbonate, carbon blacks, titanium dioxide, etc. Blends of two or more pigments also may be used. A number of useful titanium dioxide pigment slurries are available commercially such as from DuPont (e.g., R-706, R-746, R-942, etc.) and Kronos Titan, Germany (e.g., Kronos 4102 and 4311). Phosphorescent pigments, i.e., compounds that glow in the dark, also are useful colorants. Suitable phosphorescent pigments include, for example, phosphorescent pigment available under the trade designation “Excite 2330LBY” from LJSR Optonix Inc., Hackettstown, N.J. A pigment, or mixture of pigments, is typically used in an amount effective to provide the desired color.

One or more rheology control agents (thickeners) may be included in the aqueous film-forming mixtures of this embodiment to increase the viscosity of the dispersions, and the agent is incorporated into the aqueous mixtures in amounts which prevent sagging or running after the mixture is coated on a carrier to form the film. Inclusion of rheology control agents also allows for the application of thicker coatings to form thicker films. Suitable agents are those that are compatible with urethane-acrylic dispersions. As used herein, “compatible” means that the component does not have adverse effects on the aqueous mixture composition (e.g., precipitation, flocculation, or other separation of the components), on the film formed from the aqueous mixture. In one embodiment, the thickeners are associative thickeners. An “associative” thickener is a polymeric compound having hydrophobic groups that associate with the dispersed polymer particles in the aqueous mixture. This association is believed to result in adsorption of the thickener molecule onto the dispersed polymer particles.

One useful associative thickener is a polyurethane available under the trade designation “DSX-1514” from Cognis, Dusseldorf, Germany, and this thickener is an aqueous dispersion of a polyurethane having 38-42% wt solids. It is a high shear and low molecular weight thickener having a Brookfield viscosity of 2000-5000 mPa at 23° C. It is particularly desirable because it provides a significant increase in viscosity of the aqueous mixture when used in small amounts.

A thickener, or mixture of thickeners, may be present in the aqueous film-forming mixtures of this embodiment in an amount effective to increase the viscosity and stability of the dispersions and provide films having the desired properties. Generally, a thickener, or mixture of thickeners, is present in the aqueous mixture of the present embodiment in an amount of less than about 1% wt, and in another embodiment, in an amount of about 0.05-0.8% wt, based on the total weight of the aqueous mixture (including water).

Surfactants also may be included in the aqueous film-forming mixtures used in this embodiment to reduce foaming and to enhance leveling and wetting. This is important to provide smooth, uniform films. A wide variety of surfactants, i.e., surface-active agents, are suitable for use in the mixtures. Typically, additives that are suitable for use in water-based systems that perform the functions of a defoamer, leveling agent, and/or wetting agent, for example, are suitable. Suitable surfactants include, but are not limited to, flow control agents, wetting agents, dispersants, adhesion enhancers, defoamers, etc. The surfactants may be nonionic or anionic. Examples of useful surfactants are available under the general trade designations SURFYNOL® (Air Products), TRITON® (Union Carbide), SILWET® (OSi Specialties, Inc.), etc. Specific examples include SURFYNOL® SEF is a nonionic surfactant; TRITON®N-42 is a nonylphenoxy polyethoxyethanol; and SILWET® L-77, a nonionic silicone glycol copolymer. Another useful surfactant is TRITON® X-405.

A surfactant, or mixture of surfactants, may be present in the aqueous film-forming mixtures in an amount effective to provide a smooth, uniform coating. Generally, a surfactant, or mixture of surfactants, is present in the curable coating compositions of the present invention in an amount of about 0.1-3 wt-%, based on the total weight of the aqueous mixture (including water).

Flattening agents may be included in the aqueous film-forming mixtures of this embodiment to reduce the reflective characteristics (i.e., gloss) of the cured coating. Suitable flattening agents are those that are compatible with water-based systems. Particularly suitable flattening agents are silica flattening agents, which are available under the trade designations “Lo-Vel 27” and “Lo-Vel 275” (ultrafine amorphous silica) from PPG Industries, Inc., Pittsburgh, Pa. A flattening agent, or mixture of flattening agents, is typically used in an amount effective to provide the desired level of gloss to the cured coating, which is well known to one of skill in the art.

Light stabilizers may be used in the aqueous film-forming mixtures of this embodiment to enhance the UV stability of the conformable films. Suitable UV scavengers and absorbers are those that are compatible with water-based systems. One suitable UV scavenger is available under the trade designation “TINUVIN® 123 (a bis(2,2,6,6-tetramethyl4-piperidinyl)ester of decanedioic acid), which is the reaction product of 1,1-dimethylethylhydroperoxide and octane) from Ciba-Geigy Corporation, Tarrytown, N.Y. Another suitable light stabilizer is TINUVIN® 1130 (a substituted hydroxyphenyl benzotriazole) from Ciba-Geigy Corporation, Tarrytown, N.Y. Hindered amine light stabilizers (HALS) comprise another group of useful stabilizers. HALS are described and exemplified in some detail in U.S. Pat. No. 4,721,531, cols. 4-9. Such HALS may be, for example, derivatives of 2,2,6,6-tetraalkyl piperidines or substituted piperizinediones. TINUVIN® 292 is an example of a useful hindered amine light stabilizer, and is reported to be a mixture of bis(1,2,2,6,6-pentamethyl-4-piperidinyl) sebacate and methyl (1,2,2,6,6-pentamethyl-4-piperidinyl) sebacate typically used in an amount effective to provide the desired UV stability. Another useful UV stabilizer is available commercially from Clariant Corp., Augsberg, Germany under the designation SANDUVOR® S-3225. This stabilizer is a dispersion identified as a 2:1 blend of blend of a benzotriazole and a HALS.

The aqueous film-forming mixtures of this embodiment generally do not require incorporation of any cross-linking agents for film formation. However, in some embodiments it may be useful to include a cross-linking agent in the aqueous mixture.

The following Examples describe the aqueous film-forming mixtures of this embodiment and the preparation thereof. Unless otherwise indicated in the Examples, in the claims, and elsewhere in this written description, all parts and percentages are by weight, the temperature is in degrees centigrade, and the pressure is at or near atmospheric pressure.

Aqueous film-forming mixtures of this embodiment which are illustrated in Examples 1-23 are prepared in general by the following procedure. The acrylic polymer or copolymer is mixed with parts of the titanium dioxide slurry (about 76% solids) in a vessel using a mixer at 500 rpm. The acrylic-urethane copolymer is added to the mixture under stirring, and the vessel contents are mixed an additional 15 minutes. To this mixture there is then added, while stirring, 0.3 part of SANDUVOR® 3225 (UV stabilizer), 0.4 part of SURFYNOL® SEF (surfactant) and 2.5 parts of DSX1514 (thickener) diluted to 50% with water. The mixture in the vessel is mixed an additional 30 minutes, and the mixture is filtered through a 100 micron filter.

TABLE II
Example 1-23 Formulations

| | Acrylic- | Parts | Acrylic Polymer or | Parts | | Parts |
|---|---|---|---|---|---|---|
| Example | Urethane | by wt. | Copolymers | by wt. | Pigment | by wt. |
| 1 | R-9000 | 50 | Nacrylic CP 3650 | 4.6 | DuPont R-746 | 11.2 |
| 2 | R-9000 | 50 | Nacrylic 6408 | 4.6 | Kronos 4311 | 11.2 |
| 3 | R-9000 | 50 | Nacrylic 6408 | 4.6 | DuPont R-746 | 11.2 |
| 4 | R-9000 | 50 | Nacrylic 2550 | 4.6 | Kronos 4311 | 11.2 |
| 5 | R-9000 | 50 | Nacrylic 2550 | 4.6 | DuPont R-746 | 11.2 |
| 6 | R-9000 | 50 | Acronal ® 100 | 4.6 | DuPont R-746 | 11.2 |
| 7 | R-9000 | 50 | Acronal ® 100 | 4.6 | Kronos 4311 | 11.2 |
| 8 | R-9000 | 50 | Acronal ® 110 | 4.6 | Kronos 4311 | 11.2 |
| 9 | R-9000 | 50 | Acronal ® 110 | 4.6 | DuPont R-746 | 11.2 |
| 10 | R-9000 | 50 | Acronal ® 110 | 5.8 | DuPont R-746 | 11.2 |
| 11 | R-9000 | 50 | Acronal ® 110 | 7.0 | DuPont R-746 | 11.2 |
| 12 | R-9000 | 50 | Acronal ® 110 | 8.5 | DuPont R-746 | 11.2 |
| 13 | R-9000 | 50 | Acronal ® 110 | 8.5 | Kronos 4311 | 11.2 |
| 14 | R-9000 | 50 | Acronal ® 110 | 12.4 | Kronos 4311 | 11.2 |
| 15 | R-9000 | 48.7 | Acronal ® 110 | 4.98 | Kronos 4311 | 12.12 |
| 16 | R-9000 | 47.1 | Acronal ® 110 | 5.42 | Kronos 4311 | 13.2 |
| 17 | R-9000 | 60 | Acronal ® 110 | 4.6 | Kronos 4311 | 13.0 |
| 18 | R-9000 | 50 | Acronal ® 110 | 4.6 | Kronos 4311 | 15.0 |
| 19 | R-9000 | 50 | Acronal ® 300 | 4.6 | DuPont R-746 | 11.2 |
| 20 | R-9000 | 50 | Acronal ® 300 | 4.6 | Kronos 4311 | 11.2 |
| 21 | R-9000 | 50 | Acronal ® 310 | 4.6 | DuPont R-746 | 11.2 |
| 22 | R-9000 | 50 | Acronal ® 310 | 4.6 | Kronos 4311 | 11.2 |
| 23 | R-9000 | 50 | Rhoplex ® E-2780 | 4.6 | DuPont R-746 | 11.2 |

The aqueous film-forming mixtures of this embodiment, such as those described above, are useful in particular in preparing conformable films in accordance with the present invention. In one embodiment, the films are formed by casting a coating of the aqueous mixture onto a removable support by techniques well known to those skilled in the art. Examples of such techniques include screen printing, spraying, flow coating, knife coating, (e.g., knife over roll) or reverse roll coating. The choice of the technique utilized to form the coating depends upon factors such as the desired film thickness, the viscosity of the aqueous mixture, and desired film quality. In one embodiment, a release paper is used as a removable support. An example of such a removable support is a kraft paper coated with a synthetic acrylic resin. The aqueous mixtures are applied to the release support and placed in an oven. In this oven, the water is evaporated and the polymer particles fuse resulting in a dry film on the casting paper, and the dry film is easily removed from the casting paper. Films prepared in these manners may range in thickness from about 1 to about 5 mils. In one embodiment, the thickness is from about 2 to about 5 mils.

The films prepared from the aqueous film-forming mixtures of this embodiment are characterized as being flexible and having a high degree of conformability. In one embodiment, the films of the invention are characterized as having an elongation at break of about 100% or greater. In other embodiments, the elongation at break of the films of the present invention may be about 150% or greater or even about 200% or greater.

In another embodiment, the films of the present invention may be characterized as having a stress relaxation of less than about 4 Newtons. In other embodiments, the stress relaxation of the films of the invention may be less than 3 Newtons or even less than 2 Newtons. In yet another embodiment of the invention, the films are characterized as having an elongation at break of about 100% or greater and a stress relaxation of less than 4 Newtons.

The elongation at break of the films of the present invention is determined utilizing an electronic tensile tester wherein a rectangular test piece of defined width is stretched at a constant rate of elongation, and the elongation at break is the extension of the test piece at the moment of rupture expressed as a percentage of the initial test length. In this test, five test pieces of 25 mm width and at least 150 mm length are cut from the film to be tested. Each of the test pieces should be free from creases, obvious flaws or other visual defects, and free of obvious imperfections on the cut edges. The tensile tester is set for the following conditions: distance between the grips: 100 mm; grip separation speed: 200 mm/min.; force reading set to 0; and the displacement reading is set to 0. The samples are conditioned for at least 4 hours at 23°±2° C. and 50% RH±5), and the samples are tested at 23° C.±1° C.

The test piece is placed in the grips with the metal of the test piece in line with the points of attachment of the grips to the machine. The grips are tightened firmly to prevent the test piece from slipping, but not to the extent that the test piece is damaged. The pretension applied to the test piece must be in the range of 0.2 to 0.5 N. The tester is started, and the sample is stretched at a constant rate until the sample breaks. The covered distance at break is recorded. The elongation or strain at break is then calculated using the formula
Elongation at break=Δl/l×100
where Δl=the extension of the test piece at rupture, and l=the initial distance between the grips.

The elongation at break and the stress of films prepared from the aqueous mixtures of Examples 1-23 are summarized in the following Table III. The films are prepared by coating on a release liner with a knife coater or die coater, and in one embodiment, by a slot die coater. The thickness of the deposited coating is sufficient to provide a film thickness of about 2 mils after drying in an oven at 70° C. for 15 minutes.

TABLE III
Film Properties

| Film | Source | % Strain | |
|---|---|---|---|
| Example | Example | at Break | Stress. (N) |
| A | 1 | 236 | 2.5 |
| B | 2 | 209 | 3.4 |
| C | 3 | 244 | 3.2 |
| D | 4 | 247 | 2.6 |
| E | 5 | 254 | 2.6 |
| F | 6 | 296 | 1.97 |
| G | 7 | 315 | 1.7 |
| H | 8 | 277 | 1.7 |
| I | 9 | 231 | 1.72 |
| J | 10 | 244 | 1.82 |
| K | 11 | 276 | 1.71 |
| L | 12 | 111 | 1.58 |
| M | 13 | 264 | 2.37 |
| N | 14 | 221 | 2.04 |
| O | 15 | 242 | 2.65 |
| P | 16 | 212 | 2.59 |
| Q | 17 | 249 | 2.56 |
| R | 18 | 226 | 2.71 |
| S | 19 | 289 | 1.93 |
| T | 20 | 341 | 1.74 |
| U | 21 | 317 | 1.93 |
| V | 22 | 354 | 1.97 |
| W | 23 | 354 | 2.3 |

In one embodiment, the conformable film comprises a polymeric film comprising (A) at least one propylene homopolymer, copolymer or blend of two or more thereof wherein (A) has a melt flow rate from about 5 to about 40 and (B) at least one olefin elastomer. In another embodiment, the conformable film comprises a clear film comprising (A) at least one propylene copolymer having a melt flow rate of about 5 to about 40, and (B) at least one olefin elastomer. In yet another embodiment, the conformable film comprises a clear film comprising about 50% to about 90% by weight of (A) at least one propylene-ethylene or at least one propylene-butylene copolymer having a melt flow rate of about 6 to about 30, and from about 10% to about 50% by weight of (B) at least one ethylene-butylene or at least one ethylene-hexene copolymer. Such conformable films are disclosed in copending, commonly owned U.S. Published Patent Application No. 2004/0033349 A1, the disclosure of which is incorporated by reference for its teachings relating to conformable films. In one embodiment, the foregoing films are unoriented.

In one embodiment, the conformable films of the present invention are combined with a layer of adhesive to form adhesive articles such as labels for application to substrates such as portable electronic devices. The adhesive layer may comprise pressure sensitive adhesives or heat activated adhesives which are well known to those skilled in the art. A general description of useful pressure sensitive adhesives may be found in Encyclopedia of Polymer Science and Engineering, Vol. 13, Wiley-Interscience Publishers (New York, 1988). Additional description of useful pressure sensitive adhesives may be found in Encyclopedia of Polymer Science and Technology, Vol. 1, Interscience Publishers (New York, 1964). The adhesive layer of the adhesive articles can be protected by a release liner which is releasably adhered to the adhesive. Silicone treated paper is an example of a useful release liner. The adhesive articles of the present invention are readily die-cuttable into various shapes and sizes.

While the foregoing provides a detailed description of various embodiments of a conformable film, other known conformable films may be used in the conformable label in accordance with the present invention.

Inherently Printable Conformable Film

In one embodiment, the printable conformable layer comprises an inherently printable polymeric material, such as disclosed in U.S. Pat. No. 6,623,841 B1, the disclosure of which relating to printable materials is hereby incorporated by reference. Printable substrates in accordance with this embodiment are referred as being “inherently” ink receptive or, in one embodiment, inkjet printable, because the substrate surface structure is engineered to be receptive to an ink medium without subsequent topcoating, treating (e.g., corona treating or the like), and without depending on a voided or porous microstructure. Rather, substrates in accordance with this embodiment have a surface formed from a specially designed blend of a water-soluble polymer and a substantially water-insoluble polymer, which blend provides superior ink receptive properties when compared to conventional substrates having topcoated or voided surfaces. As disclosed in U.S. Pat. No. 6,623,841 B1, ink receptive substrates as applied to this embodiment of the present invention comprise a conformable base layer formed from a water-insoluble thermoplastic polymer, and an ink receptive layer disposed over the base layer. The ink receptive layer is formed from a melt processable blend of a water-soluble polymer and a substantially water-insoluble polymer, and provides an inherently ink receptive surface without further surface treatment.

Ink receptive substrates of this embodiment comprise a base layer formed from a water-insoluble thermoplastic polymer, and an ink receptive layer disposed over the base layer. In one embodiment, the ink receptive layer is formed from a melt processable blend of a water-soluble polymer and a substantially water-insoluble polymer, and provides an inherently ink receptive surface without further surface treatment. A tie layer can optionally be interposed between base and ink receptive layer.

In one embodiment, the base layer is selected from the group of thermoplastic material consisting of polyolefins, polyesters, polyurethanes, polyvinyl chlorides, polyamides, polystyrene, ethylene vinyl alcohol, and mixtures thereof. In one embodiment, the ink receptive blend comprises in the range of from 20 to 80 percent by weight water-soluble polymer, and in the range of from 80 to 20 percent by weight substantially water-insoluble polymer based on the total weight of the blend. In other embodiments, the blend may include an optional compatibilizing agent that is chemically compatible with both the water-soluble polymer and the substantially water-insoluble polymer.

In one embodiment, the blend has a melting temperature in the range of from about 100° F. to about 600° F. (about 37° C. to about 315° C.). In one embodiment, the water-soluble polymer component of the blend is selected from the group of compounds consisting of polyvinyl alcohols, polyalkyl oxazolines, polyphenyl oxazolines, polyvinylpyrrolidones, polyacrylic-acids, polymethyl methacrylates, polymethacrylic acids, styrene maleic anhydrides, alkyl celluloses, carboxyalkyl celluloses, hydroxyalkyl celluloses, polyethylene oxides, polyethyleneimines, and mixtures thereof.

In one embodiment, the water-soluble polymers include polyalkyl oxazoline and polyvinyl alcohol. The substantially water-insoluble polymer component of the blend is selected from the group of polyolefins consisting of modified and unmodified polyesters, polypropylenes, polyethylenes, polystyrenes, polybutylenes, and copolymers and mixtures thereof.

In one embodiment, the conformable base layer and ink receptive layer of ink receptive substrates of this embodiment are formed simultaneously by a coextrusion process. In one embodiment, the ink receptive substrates of this invention can include the ink receptive layer on one or both surfaces of the base layer, and/or can be constructed in the form of a pressure-sensitive adhesive label, i.e., with a pressure-sensitive adhesive material disposed on a surface of the base layer opposite the ink receptive layer.

In one embodiment, the printable conformable layer includes a base layer and an ink receptive layer disposed on one or both surfaces of the base layer. The base layer can be formed from a variety of different thermoplastic polymers depending on the substrate end use application. Suitable base layer materials for forming substrates of this invention include meltable, film-forming substances selected from the group of materials including polyolefins such as polyethylenes, polypropylenes and polybutylenes, polyvinyl chlorides, polyamides, polyesters, polystyrenes, polyurethanes, polyacrylates, polyvinyl acetate, polysulfone, polyvinylidene chloride, polyethylene methyl acrylates (EMA), polyethylene methacrylic acids (EMAA), polyethylene ethyl acrylate, nylons, polyvinyl pyrolidone, polyether esters, polyether amides, polycarbonates, styrene acrylonitrile polymer, ionomers based on sodium or zinc salts of ethylene/methacrylic acid, polymethyl methacrylates, cellulosics, fluoroplastics, acrylonitrile butadiene styrene polymer, polyethylenevinyl alcohol, and copolymers and mixtures thereof. The selected base layer material can also include fillers, pigments, processing, and/or performance aids conventionally used in the art.

In one embodiment, the ink receptive layer includes of a blend of a water-soluble polymer and a substantially water-insoluble polymer. Suitable water-soluble polymers useful for forming the ink receptive layer include, polyvinyl alcohol, polyalkyl oxazoline, polyphenyl oxazoline, polyvinyl pyrrolidone, polyacrylic-acid, polymethyl methacrylate, polymethacrylic acid, styrene maleic anhydride, methyl cellulose, ethyl cellulose, carboxymethyl cellulose, hydroxyethyl cellulose, polyethylene oxide, polyethylene-imine, and mixtures thereof. The water-insoluble polymer component of the blend is either chemically compatible with the water-soluble polymer, or is able to be compatible with the water-soluble component by the use of suitable compatibilizing agents. Materials useful for forming the ink receptive layer can further comprise cationic modifiers, wetting agents, colloidal silica, inherently dissipative polymer, water proofing agents and anti-static agents.

Additional details relating to the materials and methods applicable to this embodiment having an inherently printable conformable film may be found in U.S. Pat. No. 6,623,841 B1, the disclosure of which relating to the inherently printable conformable film is incorporated herein by reference.

Exemplary Ink Receptive Layers

In one embodiment of the present invention, the conformable label includes an ink receptive layer. In one embodiment, the conformable label includes an ink receptive layer overlying a conformable film. Any suitable ink receptive layer may be used, as long as it is compatible with the other elements of the present invention, and as long as it is printable by inkjet or other printing devices.

In one embodiment, the ink receptive layer comprises an ink receptive coating composition including (A) from about 98 parts by weight to about 60 parts by weight of a polyester resin having an Mn (number-average molecular weight) greater than 12,000, (B) from about 2 parts by weight to about 40 parts by weight of a polyester resin having an Mn in the range of from about 2,000 to 12,000, wherein the parts by weight are based on the total weight of the polyester resin in the composition, and (C) at least one crosslinking agent. In one embodiment, the polyester resin (A) has an Mn in the range of from about 15,000 to about 40,000. In one embodiment, the polyester resin (B) has an Mn in the range of from about 3,000 to about 8,000. In one embodiment, coating composition includes from about 98 to about 80 parts by weight of the polyester resin (A) and from about 2 to about 20 parts by weight of the polyester resin (B). In one embodiment, the coating composition further includes at least one organic solvent. In one embodiment, the coating composition further includes a filler, which may be an inorganic filler.

In one embodiment, the at least one crosslinking agent is a polyisocyanate and/or a polyaziridine. In one embodiment, the at least one crosslinking agent includes a polyisocyanate crosslinking agent and/or a polyaziridine crosslinking agent.

In one embodiment, the ink receptive layer may comprise one or more polyester resins, as described in U.S. Patent Application Publication No. 2004/0247837, the disclosure of which relating to ink receptive materials is incorporated herein by reference. The polyester resins may be prepared from various glycols or polyols and one or more aliphatic or aromatic carboxylic acids. Examples of useful polyester resins include resins obtained by condensation polymerization of a diol having a bisphenol skeleton or alkylene skeleton with one or more divalent or trivalent carboxylic acid. In one embodiment, the bisphenol component may be modified with ethylene glycol or propylene glycol. Examples of suitable acid components for condensation with the polyols include fumaric acid, phthalic acid, terephthalic acid, isophthalic acid, maleic acid, succinic acid, adipic acid, citraconic acid, itaconic acid, sebacic acid, malonic acid, hexacarbonic acid and trimellitic acid.

The ink receptive coating compositions of this embodiment comprise from about 98 parts by weight to about 60 parts by weight of a polyester resin having an Mn greater than 12,000. The polyester resins having an Mn of greater than 12,000 are sometimes referred to herein as high molecular weight polyester resins. The coating compositions also comprise from about 2 parts by weight to about 40 parts by weight of a polyester resin having an Mn in the range of from about 2,000 to about 12,000. The polyester resins having an Mn in the range of from about 2,000 to about 12,000 are sometimes referred to herein as low molecular weight polyester resins.

In another embodiment, the amount of the high molecular weight polyester resin contained in the ink receptive coating composition may range from about 98 to about 70 parts by weight, or from about 98 parts to about 80 parts by weight. In yet another embodiment, the coating compositions may contain from about 98 to 90 parts by weight of the high molecular weight polyester resin.

The amount of the low molecular weight polyester resin contained in the ink receptive coating composition may, in other embodiments, range from about 2 parts by weight to about 10, 20 or even 30 parts by weight. Throughout this written description and the appended claims, the parts by weight of the low molecular weight polyester resin and the high molecular weight polyester resin are based on the total weight of the polyester resin in the composition.

In other embodiments, the high molecular weight polyester resin may have an Mn of from about 15,000 to about 40,000, and the low molecular weight polyester resin may have an Mn in the range of from about 3,000 to about 8,000 or from about 3,000 to about 5,000.

A variety of high molecular weight and low molecular weight polyester resins can be utilized in the ink receptive coating composition of this embodiment. Throughout this written description and the appended claims, the term polyester includes copolyesters. The polyester resins generally are prepared from various glycols or polyols and one or more aliphatic or aromatic carboxylic acids. Examples of useful polyester resins include resins obtained by condensation polymerization of a diol having a bisphenol skeleton or alkylene skeleton with one or more divalent or trivalent carboxylic acid. In one embodiment, the bisphenol component may be modified with ethylene glycol or propylene glycol. Examples of suitable acid components for condensation with the polyols include fumaric acid, phthalic acid, terephthalic acid, isophthalic acid, maleic acid, succinic acid, adipic acid, citraconic acid, itaconic acid, sebacic acid, malonic acid, mellitic acid and trimellitic acid.

In one embodiment, the useful polyester resins may be characterized as aromatic polyester resins, saturated polyesters resins, and/or linear saturated polyesters or copolyesters. In one embodiment, the high molecular weight polyesters may be further characterized as having a hydroxyl number (mg KOH/g) of ten or less, and an acid number of less than 5. In one embodiment, the low molecular weight polyester resins useful in the present compositions, may be further characterized as being highly functional saturated polyester resins. In one embodiment, these highly functional saturated polyester resins may be characterized by having a hydroxyl number of greater than 20 and in other embodiments greater than 30 or 35 up to about 50 or more. The low molecular weight polyester resins also may be characterized as having an acid number of 5 or greater, in some embodiments, the acid number of the low molecular weight polyester resin is from about 10 to about 25.

The polyester resins useful in this embodiment may be prepared by techniques well known to those skilled in the art. In addition, useful high molecular weight and low molecular weight resins are available commercially from a variety of sources. A variety of high molecular weight polyester resins are available commercially from Bostik Findley under the general trade designation VITEL® which are identified as linear saturated copolyesters. Useful low molecular weight polyester resins are available from Reichhold Chemicals Inc. under the general trade designation FineTone™, and from Bostik Findley under the general trade designation VITEL® 5833B. Specific examples of useful low molecular weight polyester resins available from Reichhold Chemicals include: FineTone 382-ES identified as a bisphenol-A fumarate polyester; 382 ES-HMW identified as a higher molecular weight version of FineTone 382 ES; FineTone 6694 identified as a modified bisphenol A polyester; and FineTone PL-100 identified as a non bisphenol A polyester.

Characteristics of some commercially available high molecular weight polyester resins are summarized below in Table IV, and the characteristics of some low molecular weight polyester resins are summarized in Table V.

TABLE IV
High Molecular Weight Polyester Resin

| Name | Mn | Hydroxyl Number | Acid Number |
|---|---|---|---|
| VITEL ® 2200 | 24,500 | 1-3 | 3-5 |
| VITEL ® 2300 | 24,500 | 1-3 | 3-5 |
| VITEL ® 2700 | 28,000 | 1-2 | 2-5 |
| VITEL ® 7922 | 19,000 | 0-2 | 3-9 |

TABLE V
Low Molecular Weight Polyester Resin

| Name | Mn | Hydroxyl Number | Acid Number |
|---|---|---|---|
| VITEL ® 5833B | 4600 | 36.5-55.5 | 65 |
| FineTone 382 ES | 4760 | 39 | 21 |
| FineTone 382 ES-HMW | 7260 | 23 | 18 |
| FineTone 6694 | 4060 | 37 | 13 |
| FineTone PL-100 | 3900 | 43 | 5 |

The ink receptive coating compositions of this embodiment may also comprise at least one crosslinking agent which may be present in an amount which is effective for crosslinking the mixture of high molecular weight and low molecular weight polyester resin contained in the coating composition. In one embodiment, the amount of crosslinking agent(s) may vary from about 0.01 % to about 20%, or from about 0.3% to about 10%, or from about 0.5% to about 5% by weight based on the total weight of polyester resins in the coating composition. The crosslinking agents may be any of those known to those skilled in the art for crosslinking polyester resins. The crosslinking agents may be organic or inorganic. In one embodiment, the crosslinking agents are organic materials including epoxy compounds, polyaziridines, melamines, oxazolines, triazines, polyisocyanates, polyfunctional carbodiimides, etc. Examples of inorganic crosslinking agents which may be utilized include zinc ammonium carbonate, zirconium carbonate, etc.

A variety of epoxy compounds (oxiranes) are useful as crosslinking agents. Examples include, but are not limited to epoxy modified bisphenol A and epichlorohydrin epoxy resins.

Polyaziridines are derived from aziridines which are trifunctional amine compounds which may be derived from ethyleneimine. An example of a useful commercially available polyaziridine is NEOCRYL® CX 100 available from Avecia Resins, and this crosslinking agent is identified as trimethylol-tris N(methylaziridinyl))propionate. Another commercially available polyfunctional aziridine is XAMA-7 available from Bayer. An example of a commercially available carbodiimide crosslinking agent is UCARLINK® XL-29SE available from Dow Chemical.

Aliphatic and aromatic polyisocyanates may be used as crosslinking agents in the coating compositions. Any of the known polyisocyanate crosslinking agents may be used. A number of crosslinking agents are available from Bayer (Pittsburgh, Pa.) under the general trade designation DESMODUR®. For example, DESMODUR® N 3300 is an aliphatic hexamethylene diisocyanate, and DESMODUR® CB-75N is an oligomeric toluene diisocyanate.

Melamine formaldehyde resins are also useful crosslinking agents. An example of a commercially available melamine formaldehyde resin is CYMEL® 303 from Cytec.

Improved results such as improved adhesion to some polymer film substrates, improved printability and/or improved abrasion resistance exhibited by the ink receptive coating compositions of this embodiment are obtained in some embodiments when the coating compositions contain at least two crosslinking agents. Thus, for example, improved adhesion and abrasion resistance may be obtained when the coating composition contain a polyisocyanate crosslinking agent and a polyaziridine crosslinking agent. The improvement in adhesion when two or more crosslinking agents are incorporated into the coating compositions is particularly evident when the coating compositions are applied to substrates that are generally difficult to coat such as propylene polymer and copolymer substrates. In another embodiment, improved printability is observed.

The ink receptive coating compositions of this embodiment generally also comprise at least one organic solvent to dissolve the polyester resins and crosslinking agent(s). The solvents may comprise aliphatic ketones, aromatic hydrocarbons, cyclic ketones, etc., and mixtures thereof. Specific examples of useful organic solvents include methyl ethyl ketone, toluene, cyclohexanone, and mixtures of two or more of these solvents. In one embodiment, a solvent mixture comprising 10-15% by weight of methylethyl ketone, about 45-60% by weight toluene and about 3-10% by weight of cyclohexanone is useful in forming the coating compositions of the present invention. The total amount of organic solvent included in the coating compositions is an amount which is at least sufficient to dissolve the resins and other soluble components of the coating compositions. In one embodiment, the coating compositions contain from about 50% to about 80% by weight of organic solvent.

The ink receptive coating compositions of this embodiment also may, in some embodiments, contain one or more fillers. The amount of filler included may range from about 0 to about 10% by weight, based on the total weight of the polyester resin in the composition. In another embodiment the amount of filler is from 0.1 to about 10% by weight. In other embodiments, when a filler is included, it generally is included in smaller amounts such as in the range of from about 0.01% to about 3% or 5% by weight. Either organic fillers or inorganic fillers can be utilized. Examples of inorganic fillers which can be utilized include silica, colloidal silica, alumina, aluminum hydroxide, kaolin, clay, calcium carbonate, talc, titanium dioxide, etc. Commercial examples of useful fillers include SYLOID® 244, a synthetic amorphous silica from Grace Davison (Columbia, Md.); GASILE 23F, a synthetic amorphous silicon dioxide from Crosfield Chemicals (Joliet, Ill.), and HYDRAL® 710, an aluminum hydroxide from Alcoa.

The following examples illustrate the ink receptive coating compositions of this embodiment. Unless otherwise indicated in the following examples, and elsewhere in the written description and claims, all parts and percentages are by weight, temperatures are in degrees centigrade, and pressure is at or near atmospheric pressure.

| | Parts by Weight |
|---|---|
| Example A | |
| Methylethyl ketone | 10.40 |
| Toluene | 41.60 |
| Cyclohexanone | 15.00 |
| VITEL ® 2200 | 31.34 |
| FineTone 382 ES | 1.66 |
| DESMODUR ® CB 75N | 3.53 |
| Example B | |
| Methylethyl ketone | 23.06 |
| Toluene | 53.72 |
| Cyclohexanone | 5.0 |
| VITEL ® 2200 | 21.96 |
| FineTone 382 ES | 1.16 |
| SYLOID ® 234 | 0.10 |
| NEOCRYL ® CX-100 | 0.50 |
| Example C | |
| Methylethyl ketone | 12.80 |
| Toluene | 41.20 |
| Cyclohexanone | 5.00 |
| VITEL ® 2200 | 16.63 |
| FineTone 382 ES | 1.85 |
| HYDRAL ® 710 | 12.0 |
| Silica TS-100 | 0.52 |
| NEOCRYL ® CX 100 | 2.2 |
| Example D | |
| Methylethyl ketone | 20.00 |
| Toluene | 51.29 |
| Cyclohexanone | 5.00 |
| VITEL ® 2200 | 20.89 |
| FineTone 382 ES | 2.32 |
| SYLOID ® 234 | 0.50 |
| CX 100 | 0.91 |
| Example E | |
| Methylethyl ketone | 23.0 |
| Toluene | 53.72 |
| Cyclohexanone | 5.00 |
| VITEL ® 2200 | 14.64 |
| FineTone 382 ES | 0.77 |
| ZELEC ® ECM-1410M | 7.81 |
| DESMODUR ® CB-75N | 0.49 |

TABLE VI
Examples F-N (pbw)

| | F | G | H | I | J | K | L | M | N |
|---|---|---|---|---|---|---|---|---|---|
| Methylethyl ketone | 14.0 | 14.0 | 14.0 | 14.0 | 14.0 | 14.0 | 14.0 | 14.0 | 14.0 |
| Toluene | 56.0 | 56.0 | 56.0 | 56.0 | 56.0 | 56.0 | 56.0 | 56.0 | 56.0 |
| Cyclohexanone | 5.0 | 5.0 | 5.0 | 5.0 | 5.0 | 5.0 | 5.0 | 5.0 | 5.0 |
| VITEL ® 2200 | 23.27 | 23.27 | 22.05 | 20.89 | 23.27 | 22.05 | 23.27 | 23.27 | 23.27 |
| FineTone 382 ES | 1.23 | 1.23 | — | 2.32 | 1.23 | 2.45 | 1.23 | 1.27 | 1.27 |
| VITEL ® 5833 B | — | — | 2.45 | — | — | — | — | — | — |
| SYLOID ® 234 | 0.5 | — | — | — | 0.5 | 0.5 | — | — | — |
| DESMODUR ® CB 75 N | 2.3 | 2.3 | 2.3 | 2.3 | — | — | 1.0 | 2.0 | 3.0 |
| CX-100 | — | — | — | — | 0.53 | 0.97 | — | — | — |

TABLE VII

| | Examples O-Q | | |
|---|---|---|---|
| | O | P | Q |
| Methylethyl ketone | 23.06 | 23.06 | 23.06 |
| Toluene | 53.72 | 53.72 | 53.72 |
| VITEL ® 2200 | 21.96 | 21.96 | 21.96 |
| FineTone 382 ES | 1.16 | 1.16 | 1.16 |
| SYLOID ® 234 | 0.10 | 0.10 | 0.10 |
| DESMODUR ® CB-75N | 2.00 | 2.00 | 2.00 |
| CX 100 | 0.12 | 0.25 | 0.50 |

In another embodiment, the ink receptive layer includes any of a variety of such compositions known in the art. Such ink receptive compositions generally include a binder and a pigment, such as silica or talc, dispersed in the binder. The presence of the pigment decreases the drying time of some inks. A number of such ink receptive compositions are described in U.S. Pat. No. 6,153,288 (Shih et al.) and the disclosure of this patent relating to ink receptive compositions is hereby incorporated by reference.

In one embodiment, the ink receptive layer includes a composition as described in U.S. Pat. No. 6,153,288, the disclosure of which relating to ink receptive layers is incorporated herein by reference. In one embodiment, an ink receptive, coatable composition comprises a pigment dispersed in or mixed with a binder which comprises an ethylene-vinyl acetate emulsion polymer and at least one water soluble, cationic polymer. The cationic polymer fixes acid dye colorants in water-based inks, and diminishes dye diffusion. In one embodiment, the binder includes at least two water soluble, cationic polymers, namely, (1) a polymerized diallyldimethylammonium compound and (2) a copolymer of dimethylaminoethyl acrylate or methacrylate and at least one hydroxy-lower organic acrylate or methacrylate. In one embodiment, hydroxyethyl acrylate (HEA) and hydroxyethyl methacrylate (HEMA) are used. In some embodiments, a nonionic or cationic surfactant is included within the binder mixture to enhance print quality of the coating. In one embodiment, the ink receptive composition has, on a percent by weight (dry weight) basis, about 15-70% EVA emulsion polymer, about 5-50% of at least one water soluble, cationic polymer, about 20-60% pigment(s), and up to about 10% of one or more surfactants. Suitable cationic polyelectrolytes are available under the tradename Polyquat from KATPOL-CHEMIE GmbH. For example, one such cationic polyelectrolyte is Polyquat 40U 05 LV.

In one exemplary embodiment, the ink receptive layer comprises SYLOJET® LUMACOAT®301 available from Grace Davison. SYLOJET® LUMACOAT® 301 is a waterborne formulation of amorphous synthetic silica, binders and additives with a milky appearance and cationic particle charge. It may be used with synthetic substrates such as polyolefins, polyesters, and vinyl which will be printed later on small and large format printers using dye-based, waterborne and solvent-based inks. SYLOJET® LUMACOAT® 301 contains SYLOJET® silica pigments.

In one embodiment, the ink receptive layer may comprise a formulation having the following parameters:

| Ingredient | Exemplary Range Wt. % | Exemplary Wt. % |
|---|---|---|
| Water | 20-60 | 35 |
| Surfactant | 0.5-2.5 | 1 |
| Polyvinyl alcohol | 20-30 | 27 |
| Acrylic copolymer | 5-20 | 12 |
| Ammonium compound | 0.5-2.5 | 1 |
| Cationic polyelectrolyte | 1-5 | 4 |
| Hydroxyethyl methacrylate | 5-7.5 | 6 |
| Silica | 8-20 | 14 |

The specific materials for use in the above exemplary formulation include any such materials known in the art and commercially available. Such materials disclosed herein are considered suitable for use in this formulation.

In one embodiment, when coated on a conformable film face stock or conformable label stock, the ink receptive compositions provide coated products that work particularly well with ink jet printers and have a high degree of ink receptivity toward both pigment-based and dye-based inks, colored as well as black. In various embodiments, improvements are seen in color density, resolution, color gradation, drying time, smudge-proofness and water-fastness. Printed images on the coated products provided by the invention are generally crisp and have very low bleed. The coatings tend to be hydrophilic, yet water resistant, and quickly absorb water-based inks without becoming tacky or suffering a loss of integrity. Additional details relating to this embodiment may be obtained from U.S. Pat. No. 6,153,288, the disclosure of which relating to ink receptive layers is incorporated herein by reference.

In still another embodiment, the ink receptive layer comprises a mixture of at least three components: a first polymer which is a nonionic, water soluble polymer, in one embodiment, comprising one or more of polyvinyl alcohol, water soluble cellulose derivatives, gelatin, and chitosan; a second polymer, which is a water soluble amphoteric copolymer; and a surfactant, in one embodiment a water soluble polyalkylene glycol or silicone surfactant, as disclosed in copending U.S. Patent Application Publication No. 2003/0016280 A1, the disclosure of which relating to ink receptive layers is incorporated herein by reference. In one embodiment, the composition also includes a crosslinker and, in some embodiments, a pigment.

Although actual proportions of the composition can vary, in general, ink receptive compositions according to this embodiment may be prepared by mixing the three components at a relative weight ratio of about 50-90% first polymer (nonionic), about 10-50% second polymer (amphoteric), and about 1-5% polyalkylene glycol or silicone surfactant. If too much glycol or surfactant is present, the composition, when coated and dried on a substrate, may exhibit reduced water resistance.

In one embodiment, the first polymer is water soluble, or at least hydrophilic, and substantially nonionic. One example is polyvinyl alcohol (PVOH), which comes in a variety of grades and saponification levels (mole percent hydrolysis of polyvinyl acetate). Highly saponified PVOH is more soluble in water. In one embodiment, the PVOH has a saponification level of about 85 to 95%, and in another embodiment, about 87 to 89%. Other examples of water soluble, nonionic polymers include water soluble cellulose derivatives, gelatin, and chitosan. Non-limiting examples of water soluble cellulose derivatives include hydroxyethylcellulose, hydroxypropylcellulose, carboxy-methycellulose, methylhydroxycellulose, and methylhydroxypropyl cellulose. It will be apparent to persons skilled in the art that, although the aforementioned polymers contain hydroxyl groups (and, therefore, exhibit a small pKa), they are nonetheless considered to be nonionic polymers.

The second component of the composition of this embodiment is a water soluble, amphoteric copolymer. As used herein, the term “amphoteric” refers to a substance having both cationic and anionic groups within the same molecule. This definition includes molecules that become zwitterionic by adjusting the ambient pH. According to one embodiment of the invention, an amphoteric copolymer is prepared by copolymerizing a mixture of cationic and anionic monomers and, optionally, one or more neutral monomers. The neutral monomers are selected to improve polymer strength or other properties. In various embodiments, monomer weight percentages are as follows: cationic monomers: about 50 to 90%, or about 60 to 80%; anionic monomers: about 10 to 30%, or about 10 to 20%); neutral monomers: 0 to about 30%, or about 10 to 20%, based on the weight of all monomers.

In one embodiment, the cationic monomers include trialkylammoniumalkyl (meth)acrylates, e.g., N,N-dimethylaminoethyl methacrylate methyl chloride quaternary salt, CAS 5039-78-1, (a trimethylammonium chloride available from Ciba Specialty Chemicals, Tarrytown, N.Y., under the trademark AGEFLEX® FM1Q75MC); allylalkyl ammonium salts; and vinylbenzylammonium salts. A useful quaternary ammonium salt is ARQUAD® 16-29, which is believed to be hexadecyltrimethylammonium chloride, available from Armour & Co., Chicago, Ill.

In one embodiment, the anionic monomers include (meth)acrylic acid, and acrylamido methylpropane sulfonic acid (“AMPSO”). Beta-carboxyethylacrylate (beta-CEA) and itaconic acid are two other examples of anionic monomers. In one embodiment, the neutral monomers include acrylamide, dialkylaminoalkyl (meth)acrylates, hydroxyalkyl (meth)acrylates (e.g., hydroxymethyl acrylate, hydroxymethyl methacrylate, hydroxyethyl acrylate, hydroxyethyl methacrylate, hydroxypropyl acrylate, and hydroxypropyl methacrylate), and N-vinyloxazolidone.

In one embodiment, the amphoteric copolymer is formed from a plurality of monomers comprising, on a percent by weight basis, about 60 to 80% of the N,N-dimethylaminoethyl methacrylate methyl chloride quaternary salt (e.g., AGEFLEX® FM1Q75MC) noted above, about 10 to 20% (combined) acrylamido methylpropane sulfonic acid and acrylic acid, and about 10 to 20% hydroxymethyl acrylate. In one embodiment, AMPSO is the anionic monomer; including a small amount of acrylic acid facilitates copolymer crosslinking.

In one embodiment, the third component of the composition of this embodiment is a water soluble polyalkylene glycol. Non-limiting examples include polyethylene glycol (PEG) and polypropylene glycol (PPG). Also included are block copolymers of ethylene oxide and propylene oxide, such as the PLURONIC® and TETRONIC® surfactants manufactured by BASF. Polyethylene glycols are substantially water-soluble at all molecular weights. Polypropylene glycols, however, become increasingly less water-soluble at molecular weights above 425. Polyethylene glycols are particularly compatible with ink jet printer inks formulated with ethylene glycol. In one embodiment, the polyethylene glycols have a weight-average molecular weight (M_{w}) of 600 or higher, and in some embodiments about 1000 or higher. In some embodiments, the third component of the composition is a silicone surfactant. A non-limiting example is Silwet 77, from CK Witco Corporation's Organosilicones Group (Greenwich, Conn.).

In some embodiments, a crosslinker is included in the composition, to improve ink receptivity and waterfastness of the composition and coated constructions prepared therewith. Non-limiting examples of crosslinkers include dialdehydes, such as glyoxal (O═CHCH═O) and SEQUAREZ® 755 (a polyethoxylated dialdehyde from GenCorp (Fairlawn, Ohio)). In one embodiment, the crosslinker concentration ranges from about 0.5 to about 3% by weight of the composition.

In some embodiments, a pigment is included in the formulation. Ink receptive topcoats with high pigment loadings have substantial microporosity, which results in improved water resistance and faster ink drying times. The tradeoff is a loss of clarity; highly pigmented topcoats (containing, e.g., as much as 60 to 80% by weight pigment) tend to be translucent, or even opaque. If an optically clear topcoat is desired, low pigment concentrations (0 to about 20%) may be used. In many applications, however, optical clarity is not required. For example, so-called “contact clear” labels are translucent until applied to an envelope or other surface, at which point they look transparent, resulting in a “label-free” appearance.

A non-limiting example of a highly pigmented ink receptive composition according to the invention contains, e.g., 75% pigment, 20% polyvinyl alcohol, 1 to 2% amphoteric copolymer, and 3 to 4% polyethylene glycol, with a small amount (0.5 to 3%) crosslinker.

In one embodiment, very small particle size pigments like colloidal silica and colloidal alumina hydrate are used. At such a high pigment loading, little amphoteric copolymer is required. A less pigmented formulation, however, will generally contain substantially more amphoteric copolymer, in order to achieve the desired ink receptivity.

Ink receptive compositions are readily prepared by mixing the components using standard blending techniques known to those skilled in the art. In embodiments containing a pigment, the amphoteric copolymer may be added last, to avoid precipitation.

In one embodiment, the composition is applied to a substrate using standard coating techniques. Non-limiting examples include slot die, air knife, brush, curtain, extrusion, blade, floating knife, gravure, kiss roll, knife-overblanket, knife-over-roll, offset gravure, reverse roll, reverse-smoothing roll, rod and squeeze roll coating. Coat weights are variable and depend on the choice of facestock, the coating method and apparatus used, the desired drying time (both of the coating and ink to be imprinted thereon), and other factors known in the art. A label construction with a paper facestock can be prepared with an ink receptive composition coat weight of, e.g., about 10 to about 20 g/m² (dry weight) on film or about 7 to about 10 g/m² (dry weight) on paper. For comparison, a plastic sheet protector may have a much lower coat 2 weight, e.g., 7 to 10 g/m². Other applications may use substantially higher coat weights.

In one embodiment, a coatable ink receptive composition is provided and comprises a mixture of polyvinyl pyrrolidone, silica, and a chromium complex capable of crosslinking polyvinyl pyrrolidone, as disclosed in copending U.S. application Ser. No. 09/726,196, filed 29 Nov. 2000 and entitled INK JET-PRINTABLE MEDIA (published as WO 02/43965 A2), the disclosure of which relating to ink jet-printable materials is incorporated herein by reference.

In one embodiment, the components are dissolved or dispersed in a solvent. In other embodiments, additional components can be added to improve pot life, coatability, and other properties as described below.

In general, in this embodiment, the coatable ink receptive compositions contain, on a parts-by-weight basis, from about 2 to 30% (in one embodiment about 5 to 20%) polyvinyl pyrrolidone, about 2 to 10% (in one embodiment about 3 to 7%) silica, and about 0.25 to 1% chromium complex. Where a solvent is present, it comprises from about 50 to 95% (in one embodiment about 75 to 95%) of the composition.

It has been found that the molecular weight of the polyvinyl pyrrolidone (PVP) can affect the viscosity and solids content of the composition, which in turn affects the coating speed and cost of making ink receptive products coated with the composition. In general, compositions prepared in accordance with this embodiment utilize PVP having a K value of from about 60 to 100 and a weight average molecular weight (M_{W}) of from, about 300,000 to 2,500,000. In one embodiment, the PVP has a K value of from about 75 to 90 and a M_{W} of from about 750,000 to 1,000,000. PVP is available from a number of companies, including ISP Technologies, Inc. and BASF.

The silica component imparts ink absorptivity and ink permanency to the coated construction. Several types of silica are known, with varying pore size (and hence, varying ink absorptivity), including fumed silica, precipitated silica, and silica gel. Silica gel has the highest pore volume. A non-limiting example is GASIL® HP-39, from Crosfield Company (Joliet, Ill.).

The chromium complex present in the composition is capable of crosslinking polyvinyl pyrrolidone. In one embodiment, such a complex is QUILON® C, made by E.I. du Pont de Nemours and Company. Other grades of QUILON® complexes are also available. Du Pont product literature describes QUILON® as “a solution, largely in isopropanol, of a dark green, chemically reactive complex in which a C₁₄-C₁₈ fatty acid is coordinated with trivalent chromium.” QUILON® C has CAS Registry No. 65229 5. It has been described as pentahydroxy(tetradecanoato) dichromium.

A number of organic and mixed organic/aqueous solvents can be used to prepare coatable compositions according to this embodiment of the present invention. In one embodiment, the solvent is an alcohol. In another embodiment, the solvent is a mixture of alcohol and water. Alternatively, other organic solvents may be used. Although alcoholic compositions can be prepared using methanol or ethanol, in commercial-scale production, an alcohol with a high boiling point may be used, for example, n-butanol (b.p.=117.7° C.). In those embodiments where a mixture of alcohol and water is employed as the solvent, the alcohol may be isopropanol, which is much more miscible with water than is n-butanol.

To improve the pot life of water-free compositions, in one embodiment an organic acid, for example, acetic acid, is added prior to coating. Although not bound by theory, it is believed that the acid retards the chromium complex-catalyzed crosslinking of PVP at room temperature, thus improving the pot life of the composition and facilitating coating in conventional coaters. In organic solvent-based compositions lacking an acid, the viscosity of the composition may build undesirably with time, making it extremely difficult to coat the composition. If included, the organic acid is present in a positive amount up to about 5%, in one embodiment from about 0.1 to 5%, based on the weight of all components.

The ink receptivity of mixed alcohol/water-based systems can be improved by the addition of a mordant, such as polyethylene imine (PEI). For example, a positive amount up to about 25%, in one embodiment from about 1 to 10%, of an aqueous PEI solution is included in some embodiments of the invention. It has been found that adding neat PEI to the composition can cause gelling. This can be avoided by pre-diluting the PEI with water.

The coatable compositions are prepared by mixing polyvinyl pyrrolidone, silica, chromium complex and other components (e.g., solvent, organic acid, PEI, etc.) using mixing techniques and apparatus well known in the art. The chromium complex, as well as any organic acid, may be added to the composition just prior to coating. Once the components are mixed, the composition can be stored with continuous mixing for at least one month without chromium complex, and up to 8-10 hours with the complex.

In one embodiment, the above ink receptive coating composition is applied to a transparent film layer and dried. Subsequently, an ink layer is printed onto the resulting ink receptive layer using an ink jet printer as described herein.

In other embodiments, other known ink receptive materials may be used for the ink receptive layer.

Tie or Primer Layer

In one embodiment, a tie layer and/or a primer layer can be interposed between the conformable base layer and the ink receptive layer. The tie layer may be, for example, a coating composition such as that disclosed in WO 02/062894 for obtaining a topcoat. The coating composition disclosed in WO 02/062894 includes a) at least one binder and b) at least one filler having a surface area of at least about 1 m²/g. As disclosed in WO 02/062894, the topcoat derived from the coating composition is printable with a UV curable ink-jet ink. Although the coating composition is disclosed as a printable layer, the present inventors have discovered that this composition, in addition to the features thereof disclosed in WO 02/062894, also functions well as a tie or primer layer, when located between the conformable base layer and the ink receptive layer overlying the base layer, in such embodiments of the present invention.

In one embodiment, the binder used in forming the tie layer of this embodiment may be any film forming monomer, oligomer or polymer or combinations thereof. Examples of useful binders include polyurethanes, polyacryls, polymethacryls, thermoplastic polymers of ethylene and propylene, ionomers, polyesters, polyamides, polyvinyl alcohols, polyvinyl pyrrolidinones, polyolefins, proteins, including gelatins, cellulosic resins including starches, rubbers, vinyl acetatehomopolymers and co-or terpolymers, polystyrenic resins, and combinations and blends of two or more thereof. Generally the binder is present in a major amount. Typically the binder composition is present in an amount from about 40% to about 90%, or from about 50% to about 85%, or from about 55% to about 75% by weight of the solids of the composition used for the tie layer of this embodiment.

In one embodiment, the binder used in forming the tie layer of this embodiment is a film-forming polymer, such as polyurethanes, polyacryls, polymethacryls, polyurethane-polyacryl mixtures, polyurethane-polymethacryl mixtures, urethane-acrylate or methacrylate copolymers, and mixtures thereof. As used herein, a “polyacryl” includes a polyacrylate, polyacrylic, or polyacrylamide. As used herein, a“polymethacryl” includes a polymethacrylate, polymethacrylic, or polymethacrylamide.

In one embodiment, the filler used in forming the tie layer of this embodiment has a surface area of at least 1 M²/g. In another embodiment, the surface area of the filler is greater than 5, or greater than 10, or greater than 20 M²/g. In another embodiment, the fillers are those having a surface area of greater than 200 M²/g. The surface area of the filler is determined by BET (Brunauer, Emmett and Teller) method described in J. American Chemical Society Vol. 60, page 309 (1938). This method is based on the adsorption of gaseous nitrogen.

Examples of suitable fillers include silica, such as amorphous silica, fumed silica, colloidal silica, precipitated silica and silica gels. Additional fillers include a silica, a clay, an alkaline earth metal sulfate or carbonate, an alkaline earth or transition metal oxide or hydroxide. In one embodiment, the filler is a silica having a surface area of at least about 40, or at least 60, or at least about 100 M²/g. In another embodiment, the filler is a silica with a surface area of at least 150, or at least about 200, or at least about 250 M²/g.

The filler used in forming the tie layer of this embodiment is typically present in a minor amount. In one embodiment, the filler is present in an amount from about 5% up to about 49%, or from about 10% up to about 40%, or from about 15% to about 35%. In another embodiment, the filler is present in an amount greater than 20%, or greater than 30% and up to about 50%, or 45% (percent values are by weight). In one embodiment, the filler to binder ratio is at least 0.01 to about 2, or from about 0.3 to about 1.5 or from about 0.5 to about 1.

Additional details relating to the tie layer in this embodiment may be obtained from WO 02/062894, the disclosure of which is incorporated herein by reference.

Another suitable tie or primer layer is a proprietary material available from Huhtamaki under the trade designation TC15 which is a gravure coated silica-filled acrylic emulsion.

In one embodiment, the thickness of the base film, a cast extruded polypropylene, is 50 μm. Grammage of the topcoat is between 1 and 15 gram/m².

In one embodiment, the tie layer may comprise any polymeric material that improves the adhesion of the ink receptive layer to the conformable base layer. In one embodiment, the tie layer comprises a mixture of a propylene homopolymer or copolymer and a soft polar additive (“SPA”) such as ethylene vinyl acetate copolymer (EVA). Any of the propylene homopolymers or copolymers described above as useful in embodiments of the conformable base layer can be used in the tie layer. The weight ratio of the propylene polymer or copolymer and the SPA in the blend may range from about 50/50 to 60/40. The soft polar additives generally comprise random copolymers of an olefin and a more polar moiety. In one embodiment, the soft polar additive is ethylene vinyl acetate copolymer (EVA). In another embodiment, the tie layer may include other soft polar additives such as ethylene methylacrylate (EMA) and acrylonitrile butadiene rubber.

Particular examples of such blends useful as the tie layer include a blend containing 50% EVA and 50% of a random propylene copolymer containing about 6% ethylene; a blend of 60% EVA and 40% of a propylene homopolymer; and 50% EMA and 50% of a propylene homopolymer. Specific examples of ethylene vinyl acetate copolymers useful in the tie layer are those containing 18% vinyl acetate and 28% vinyl acetate.

The tie layer also may comprise polar additives such as ethylene methylacrylate (EMA) without any additional propylene polymer. Examples of a useful commercially available EMA include EM-803-115 (melt index=3.5), EM 806-009 (melt index=6.0) and EM 802-009 (melt index=2.0) available from Equistar, Houston, Tex.

The tie or primer layer may include, for example, a coating 0.1 to 5 microns thick.

System for Providing a Decorative Label

In one embodiment, the present invention further relates to a system for providing a decorative label for application to a substrate such as a portable electronic device, including: a computer system including a display device, an input device, and a printer; a source available to the computer system of a plurality of images displayable on the display device and printable on the printer; a program installed and operable on the computer system capable of obtaining and displaying on the display device the plurality of images, selecting one of the plurality of images and printing with the printing device the selected one image; and a sheet having a printable front surface and an adhesive coated rear surface, the sheet being pre-cut into one or more conformable label of a predetermined size and being provided to the printer for printing, in which the computer system with the program is operable via the input device to display the plurality of images on the display device, to select the selected one image, to align the selected one image with a selected one of the one or more conformable label, to print the selected one image on the selected one conformable label, and to provide to a user the sheet with the printed conformable label, and in which the user can remove the printed conformable label from the sheet and apply the printed conformable label to conform to a rear surface of the substrate.

In one embodiment, the system includes the features needed to carry out the method of personalizing a portable electronic device described above. All of the descriptions set forth above with respect to the method of personalizing a portable electronic device are applicable to this embodiment of the invention, so are not repeated here.

The system for providing a decorative label is described with respect to the drawings.

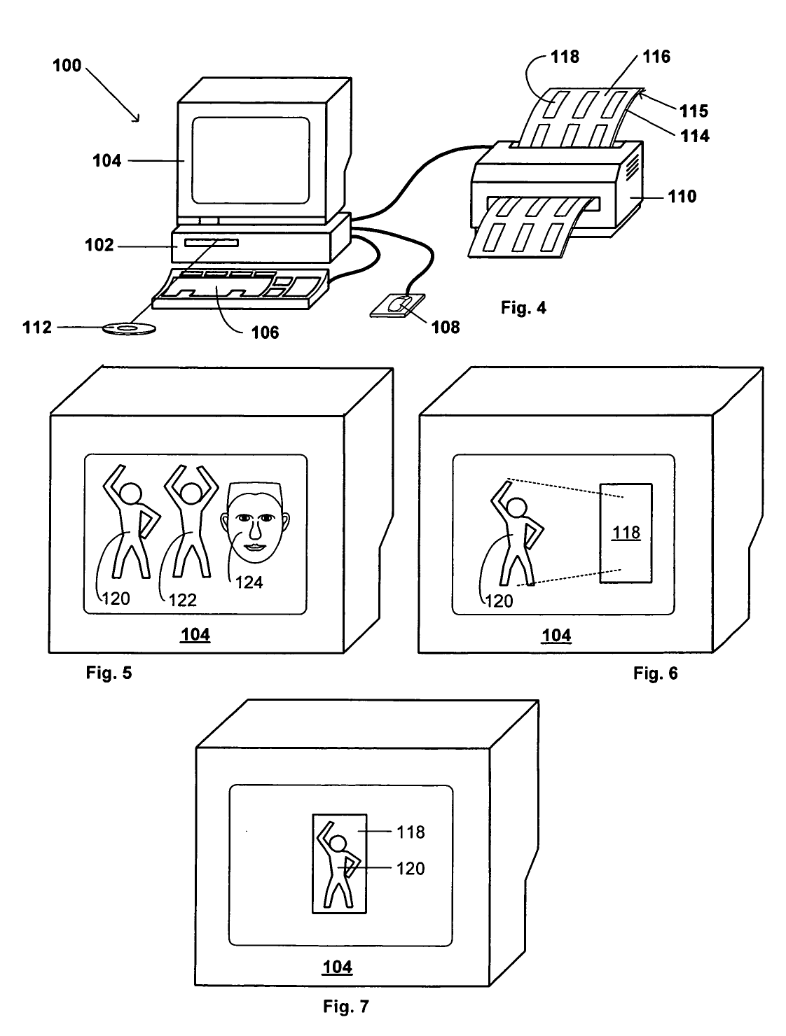

FIG. 4 is a schematic perspective view of a system 100 for carrying out the method of one embodiment of the present invention. As shown in FIG. 4, in one embodiment, the system 100 includes a computer system with standard components such as a CPU 102, a display device 104, input devices such as a keyboard 106 and a mouse 108, and a printer 110. The system may include various sources available to the computer system of a plurality of images displayable on the display device and printable on the printer. In one embodiment, the source may be a CD or DVD disc 112, as shown in FIG. 4.

As shown in FIG. 4, a sheet 114 having a printable front surface 116 and an adhesive coated rear surface (such as the adhesive layer 24 or 34 shown in FIGS. 1 and 2, respectively) is provided to the printer 110 for printing. As shown in FIG. 4, the sheet 114 may be pre-cut into one or more conformable label 118 (similar to the pre-cut labels 20 in FIG. 3). An embodiment of a method of using the system 100 is described in the following. In one embodiment, the sheet 114 further comprises a carrier sheet 115. In one embodiment, the carrier sheet 115 is release coated.

Method of Providing a Decorative Label

In another embodiment, the present invention further relates to a method of providing a decorative label for application to a substrate such as a portable electronic device, including steps of providing a source of a plurality of images; providing a computer system having a display device, an input device, and a printer, the computer system programmed to obtain from the source, display on the display device, select with the input device one of the plurality of images and print with the printing device the selected one image; providing a sheet having a printable front surface and an adhesive coated rear surface, the sheet being divisible into one or more conformable label of a predetermined size and being provided to the printer for printing; operating the computer system with the input device to obtain from the source the plurality of images, display the plurality of images on the display device, to select one image from the plurality of images, to align the selected one image with a selected one of the one or more conformable label, to print the selected one image on the selected conformable label, and to provide to a user the sheet with the printed conformable label, and removing the printed conformable label from the sheet and applying the printed conformable label to conform to a rear surface of the portable electronic device. By carrying out the method in accordance with this embodiment of the invention, a user can prepare on a home computer system equipped with a printer a customized conformable label for application to, e.g., a portable electronic device.

In one embodiment, the above-described method employs the features of the above-described system to provide the decorative labels. The decorative labels can by used, for example, for personalizing a portable electronic device, as described above. The method is briefly described with respect to the drawings in the following.

FIGS. 5-7 are schematic depictions of the display of a system such as that shown in FIG. 4 during steps of a process in accordance with an embodiment of the present invention.

As shown in FIG. 5, one or more, or a plurality, of images are provided to the user and displayed on the display 104. In the exemplary embodiment illustrated in FIG. 5, three images 120, 122, 124, are displayed. The user can select any one or more of the displayed plurality of images. In most cases, the user will select a single image.

As shown in FIG. 6, as an example, the user selects the image 120. As shown in FIG. 6, the selected image 120 can be shown on the display in relation to the selected conformable label 118. In one embodiment, the user can then select how the selected image 120 will be arranged on the conformable label 118, and can make desired changes, such as scaling or orienting the selected image 120 to fit on the selected conformable label 118 or to provide a desired orientation of the image. In one embodiment, in addition to changes in size and orientation of the images, the user can modify other properties of the image, including such characteristics as colors, brightness, contrast, backlighting, flash fill, etc., and in one embodiment, the user can also make changes such as distorting the image or parts thereof in any desired manner. Software capable of making such changes in images displayed on a computer system is widely available and well known in the art.

As shown in FIG. 7, when the selected image 120 has been arranged with respect to the conformable label 118, it is now ready for printing. When the conformable label 118 has been printed with the image 120 thereon, it is then provided to the user. Then, the user can remove the conformable label 118 from the sheet 114, for application of the conformable label to conform to a rear surface of a selected portable electronic device.

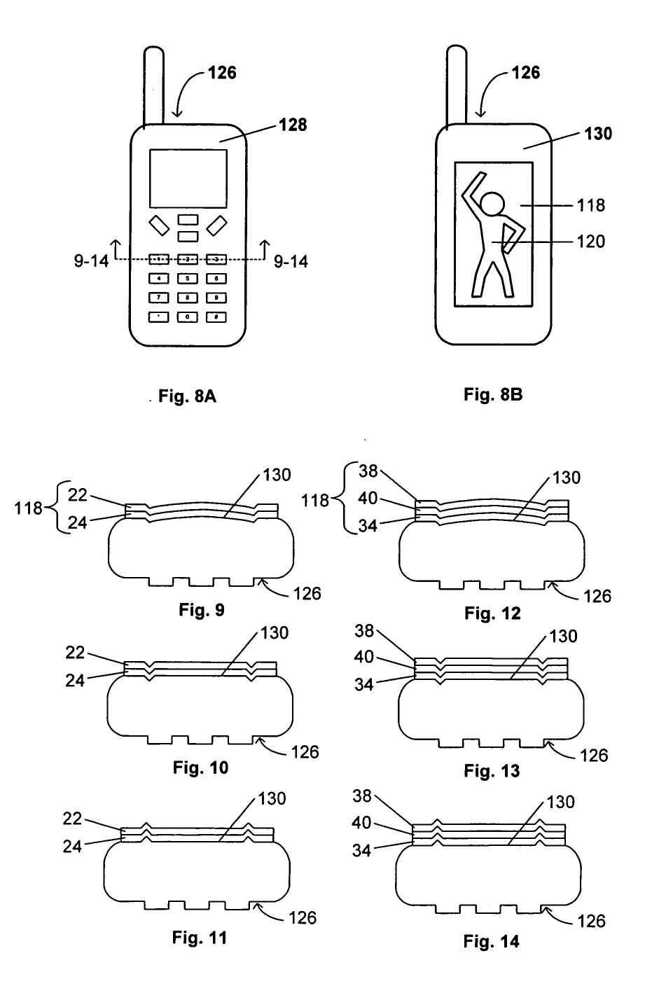

FIGS. 8A and 8B are schematic depictions of a portable electronic device, in this example, a cell phone 126, including a front surface 128 and a rear surface 130. As shown in FIG. 8B, the decorative conformable label 118 with the selected image 120 has been applied conformably to the rear surface 130, in accordance with an embodiment of the present invention.

FIGS. 9-14 are schematic cross-sectional views of the cell phone of FIGS. 8A and 8B, taken at line 9-14—9-14 of FIG. 8A, depicting a decorative conformable label applied to the rear surface of the cell phone, in accordance with several embodiments of the present invention.

FIGS. 9-11 illustrate an embodiment of the conformable label which includes two layers: the ink receptive conformable layer 22 and an adhesive layer 24, applied to the rear surface 130 of the cell phone 126. FIGS. 9-11 illustrate several examples of different rear surfaces 130 to which the conformable label of the present invention can be conformably applied.

FIGS. 12-14 illustrate an embodiment of the conformable label which includes three layers: the ink receptive layer 38, the conformable layer 40 and the adhesive layer 34, applied to the rear surface 130 of the cell phone 126. FIGS. 12-14 illustrate several examples of different rear surfaces 130 to which the conformable label of the present invention can be conformably applied.

Decorated Substrate

In one embodiment, the present invention relates to a decorated substrate, which has been decorated by application of a printed conformable label such as that made by the methods described herein. Thus, in this embodiment, the decorated substrate comprises a substrate, such as a portable electronic device, having a surface onto which a conformable, printed label can be applied. In one embodiment, the conformable printed label has a printable surface which has been printed with a printer and separated from a sheet comprising one or more such conformable labels. In one embodiment, the image printed on the conformable label has been selected from a plurality of images. The conformable label may be any of the conformable labels, and may comprise any of the materials described herein.

In another embodiment, the present invention relates to a decorated substrate comprising a substrate having a surface, the surface comprising a discontinuity; a decorative printed conformable label having an upper surface and a lower surface, wherein the lower surface is decoratively applied to the surface of the substrate, wherein the upper surface comprises a printable layer and the lower surface comprises an adhesive coating, the adhesive conformably adhering the label to the substrate, and wherein the printable layer comprises a decorative design printed thereon.

In one embodiment, the present invention further relates to a printed conformable label adapted to be applied to a substrate to form a decorative label on the substrate, in which the substrate has discontinuities in the surface to which the conformable label is to be applied. In accordance with an embodiment of the invention, the printed conformable label can be conformably applied to the surface, and the label will adhere and remain adhered even to the discontinuities in the surface. As described herein, the substrate may be, for example, a portable electronic device. In one embodiment, the conformable label has a printable surface which has been printed with a printer and has been separated from a sheet comprising one or more such conformable labels. In one embodiment, the image printed on the conformable label has been selected from a plurality of images. The conformable label may be any of the conformable labels, and may comprise any of the materials described herein.

In another embodiment, the present invention relates to a printed conformable label for application to a substrate, the label comprising a printable layer disposed on a first side of a conformable film, wherein the conformable film comprises an adhesive layer applied to a second side thereof, wherein the label comformably adheres via the adhesive layer to a surface of a substrate, the surface including surface discontinuities to which the conformable label is desired to conform, the label conformably remaining adhered to the surface and surface discontinuties for a period of about 10 days or more following application when stored at room temperature.

Conformability Example

The following example illustrates the conformability of an embodiment of the printable conformable label of the present invention, and the difference between the label of the present invention and other printable labels not including a conformable film.

The stress relaxation property of the films in this example are determined as described above. A sample of the film (150 mm in length) is placed between the grips providing a grip to grip distance of 25 mm. The test speed is 100 mm/min. The test is executed by stretching the film 13%, and the film is maintained at this elongation of 13% for 12 minutes. During this time, the force is reduced due to the relaxation of the sample, and the force at 12 minutes is recorded as the stretch relaxation of the film.

The stress relaxation of three films used in this example are:

| Sample | Material | Stress relaxation, N | Relaxation % |
|---|---|---|---|
| A | PET 50 w/ink receptive | 108 N | 33.6 |
| | topcoat | | |
| B | PP100 with 12 μm | 32 N | 52.6 |
| | topcoat | | |
| C | Avery IPM1900 50 μm | 6.9 N | 72 |
| | base layer + 50 μm ink | | |
| | receptive topcoat | | |

Each of the materials has a pressure-sensitive adhesive layer on the side opposite the inkjet receptive topcoat, and a release liner covering the adhesive. In the tests, a piece of each material having dimensions 111 mm×51 mm is cut from a sheet of the material; the release liner is removed. Each sample A, B and C is applied to the rear surface of a Nokia 6310 cell phone, which has a long indent. The samples are manually applied by aligning the label in the longer direction of the phone, aligning and applying the label to the rear surface of the phone, then manually spreading and smoothing the label material outwardly towards the sides. The label is firmly pressed against the surface of the cell phone to eliminate bubbles and any unevenness.

Sample A cannot follow the indent at all. Sample B initially conforms to the indent, but after several minutes the stress relaxation force causes the film to separate from and bridge over indent. Both Samples A and B formed “wings” at the corners, where the material extended over the curve of the phone. Sample C easily follows the indent and remains in place even after an extended period of several days. Sample C did not form “wings” at the comers, where the material extended over the curve of the phone, but instead could be pressed to conform to the surface of the phone at the corners.

Electronic Display of Image in Customized Conformable Label

In another embodiment, with appropriate software, the user may display the selected image as a wallpaper in a display portion of the portable electronic device, as well as printing the image onto the conformable label of the present invention to be applied to the surface of the portable electronic device. In this embodiment, once the user has selected an image for printing, the selected image is transferred, by appropriate software and hardware connections, to a target device such as a cell phone for display in the electronic display of the cell phone, such as in a wallpaper or background of the display. Thus, in such an embodiment, the user can combine two forms of customization of the electronic device, that is, for both printed and electronically displayed images. Appropriate hardware is known for electronically transferring information, including data and images, to a portable electronic device capable of displaying such information.

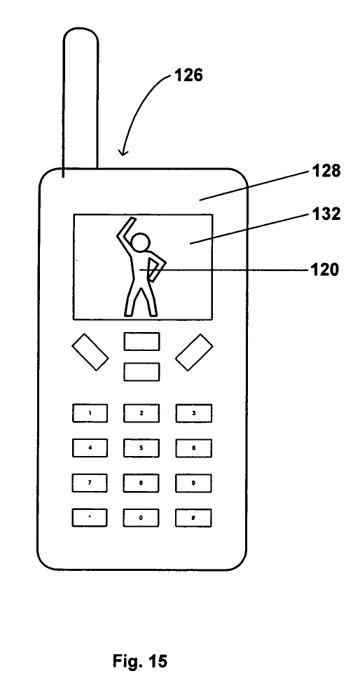

FIG. 15 is a schematic depiction of a cell phone 126 in which an electronic copy of an image 120 has been provided to the cell phone for display as a wallpaper in the cell phone display area 132 on the front surface 128 of the cell phone 126.

In accordance with this embodiment, in the above described system, there is also provided a cable or other known wired or wireless communication means for communicating between the CPU and the portable electronic device to be personalized.

Further, in accordance with this embodiment, the method of personalizing a portable electronic device may further include a step of transferring the selected one or more image to the portable electronic device in an electronic form, and a step of displaying the selected one or more image on a display component of the portable electronic device. Such a display may be the display of a cell phone, or a PDA, or a laptop or notebook computer, or any other suitable display on the particular portable electronic device of the user. In one embodiment, all or a portion of the selected image may be displayed as a wallpaper or background, and in one embodiment, the wallpaper or background may be coordinated with the image selected for printing on the conformable label. Thus, for example, a portion of the image may be printed, and another portion, or the entirety, of the image may be displayed on the wallpaper or background. Transfer of the electronic image to the portable electronic device may be accomplished by suitable electrical/electronic or radiation (e.g., IR beam) connection, as known in the art for use in transferring data to such devices.

While the invention has been explained in relation to various of its embodiments, it is to be understood that various modifications thereof will become apparent to those skilled in the art upon reading the specification. Therefore, it is to be understood that the invention disclosed herein is intended to cover modifications as fall within the scope of the claims.

1. A method of personalizing a portable electronic device, comprising:
providing a portable electronic device having a front surface and a rear surface;
providing a sheet having a printable front surface and an adhesive coated rear surface, the sheet being divisible into one or more conformable label, wherein the conformable label comprises a conformable film having a stress relaxation in the range from about 1 to about 12 Newtons;
providing in electronic format a plurality of images printable by a printer;
selecting from the plurality of images one or more image for printing;
printing the selected one or more image on the printable surface of the sheet;
separating one or more printed conformable label from the sheet; and
conformably applying the printed conformable label to a surface of the portable electronic device.

2. The method of claim 1 wherein the surface of the portable electronic device includes one or more discontinuity to which the conformable label conforms.

3. The method of claim 1 wherein the sheet comprises a carrier sheet overlying the adhesive coated rear surface and wherein optionally the carrier sheet is release-coated.

4. The method of claim 1 wherein the portable electronic device is one of a telephone or telephone handset, a cellular telephone, a radio telephone, a walkie-talkie, a personal digital assistant, a handheld, notebook or desktop computer, a digital camera, a game console, an MP3 player, a CD player or a DVD player.

5. The method of claim 1 wherein the one or more conformable label is divisible by being pre-cut into a predetermined size.

6. The method of claim 1 further comprising adjusting a size of the selected image for printing to fit the predetermined size of the label.

7. The method of claim 1 further comprising removing the printed conformable label from the device and replacing the removed label with another conformable label printed with one or more of the plurality of images.

8. The method of claim 1 wherein the at least one image may be obtained in electronic format on a user's computer from a source comprising one or more of an internet site, a digital camera, a magnetic data storage medium, an optical data storage medium and a scanner.

9. The method of claim 1 further comprising electronically transferring the at least one image in electronic format to the portable electronic device for electronic display thereby.

10. The method of claim 1 wherein the sheet having a printable surface further comprises an ink receptive layer overlying the conformable film.

11. The method of claim 10 wherein the ink receptive layer comprises an ink receptive coating composition comprising:
(A) from about 98 parts by weight to about 60 parts by weight of a polyester resin having an Mn greater than 12,000,
(B) from about 2 parts by weight to about 40 parts by weight of a polyester resin having an Mn in the range of from about 2,000 to 12,000, wherein the parts by weight are based on the total weight of the polyester resin in the composition, and
(C) at least one crosslinking agent.

12. The method of claim 1 wherein the sheet having a printable surface further comprises a tie or primer layer between the ink receptive layer and the conformable film.

13. The method of claim 1 wherein the conformable film comprises an elongation at break of about 100% or greater, about 150% or greater or about 200% or greater.

14. The method of claim 1 wherein the conformable film comprises a vinyl halide film comprising (A) at least one vinyl halide polymer, (B) at least one non-halogenated polymeric plasticizer and (C) at least one second plasticizer, wherein a major amount of the polymers of the film comprise the vinyl halide polymer (A) and wherein the film has an elongation at break of about 50% or greater.

15. The method of claim 14 wherein (B) is present in an amount of less than 40 parts per hundred parts of (A).

16. The method of claim 14 wherein (C) is present in an amount from about 20 to about 85 parts per hundred parts of (A).

17. The method of claim 1 wherein the conformable film is prepared from an aqueous film-forming mixture comprising, based on the weight of the solids, (A) from about 50% to about 80% by weight an acrylic-urethane copolymer which forms a film having an elongation at break of about 300% or greater, and (B) from about 5% to about 25% by weight of an acrylic polymer or copolymer having a T_{g} of less than about 55° C., wherein the acrylic polymer or copolymer (B) is different from the acrylic-urethane copolymer (A).

18. The method of claim 1 wherein the conformable film comprises a multilayered thermoplastic film, comprising a thermoplastic core layer having a first side and a second side, the core layer comprising:
(a) a polyolefin having a density in the range of about 0.89 to about 0.97 grams per cubic centimeter;
(b) from about 2% to about 25% by weight of a second polymeric material selected from ionomers derived from sodium, lithium or zinc and an ethylene/unsaturated carboxylic acid copolymer; and
optionally (c) a light stabilizer at a concentration of about 1000 to about 10,000 ppm based on the weight of the core layer when present;
at least one abrasion resistant first thermoplastic skin layer overlying the first side of the core layer;
at least one second thermoplastic skin layer overlying the second side of the core layer.

19. A system for providing a decorative label for application to a portable electronic device, comprising:
a computer system including a display device, an input device, and a printer;
a source, available to the computer system, of a plurality of images displayable on the display device and printable on the printer;
a program installed and operable on the computer system capable of obtaining and displaying on the display device the plurality of images, selecting one or more of the plurality of images and printing with the printer the selected one or more image; and
a sheet having a printable front surface and an adhesive coated rear surface, the sheet being divisible into one or more conformable label and being provided to the printer for printing, wherein the conformable label comprises a conformable film having a stress relaxation in the range from about 1 to about 12 Newtons;
wherein the computer system with the program is operable via the input device to display the plurality of images on the display device, to select the selected one or more image, to align the selected one or more image on the sheet, to print the selected one or more image on the sheet, and to provide to a user the sheet with the printed image thereon, and
wherein the user can remove one or more printed conformable label from the sheet and apply the printed conformable label conformably to a surface of the portable electronic device.

20. The system of claim 19 wherein the surface of the portable electronic device includes one or more discontinuity to which the conformable label conforms.

21. The system of claim 19 wherein the sheet comprises a carrier sheet overlying the adhesive coated rear surface and wherein optionally the carrier sheet is release-coated.

22. The system of claim 19 wherein the portable electronic device is one of a telephone or telephone handset, a cellular telephone, a radio telephone, a walkie-talkie, a personal digital assistant, a handheld, notebook or desktop computer, a digital camera, a game console, an MP3 player, a CD player or a DVD player.

23. The system of claim 19 wherein the computer system with the program is operable via the input device to adjust a size of the selected image for printing to fit a predetermined size of the conformable label.

24. The system of claim 19 wherein the user can remove the printed conformable label from the portable electronic device and replace the removed label with another conformable label printed with one or more of the plurality of images.

25. The system of claim 19 wherein the computer system with the program is operable via the input device to obtain the one image in electronic format for display on the user's computer from a source comprising one or more of an internet site, a digital camera, a magnetic data storage medium, an optical data storage medium and a scanner attached to the user's computer.

26. The system of claim 19 further comprising means for electronically transferring the at least one image in electronic format to the portable electronic device for electronic display thereby.

27. The system of claim 19 wherein the sheet having a printable surface comprises an ink receptive layer overlying a conformable film.

28. The system of claim 19 wherein the conformable film has an elongation at break of about 100% or greater.

29. The system of claim 19 wherein the sheet is divisible into the one or more conformable label by being pre-cut to a predetermined size.

30. A method of providing a decorative label for application to a portable electronic device, comprising:
providing a source of a plurality of images;
providing a computer system having a display device, an input device, and a printer, the computer system programmed to obtain from the source, display on the display device, select with the input device one on more of the plurality of images and print with the printer the selected one or more image;
providing a sheet having a printable front surface and an adhesive coated rear surface, the sheet being divisible into one or more conformable label, wherein the one or more conformable label comprises a conformable film having a stress relaxation in the range from about 1 to about 12 Newtons, and being provided to the printer for printing;
operating the computer system with the input device to obtain from the source the plurality of images, to display the plurality of images on the display device, to select one or more image from the plurality of images, to align the selected one or more image with a selected one or more conformable label, to print the selected one or more image on the selected one or more conformable label, and to provide to a user the sheet with the printed one or more conformable label, and
removing the printed one or more conformable label from the sheet and applying the printed one or more conformable label conformably to a surface of the portable electronic device.

31. A decorated substrate comprising:
a substrate having a surface, the surface comprising a discontinuity;
a decorative printed conformable label having an upper surface and a lower surface, wherein the conformable label comprises a conformable film comprising a stress relaxation in the range from about 1 to about 12 Newtons, wherein the lower surface is decoratively applied to the surface of the substrate, wherein the upper surface comprises a printable layer and the lower surface comprises an adhesive coating, the adhesive conformably adhering the label to the surface, and wherein the printable layer comprises a decorative design printed thereon.

32. A printed conformable label for application to a substrate, the label comprising:
a printable layer disposed on a first side of a conformable film, wherein the conformable film comprises a stress relaxation in the range from about 1 to about 12 Newtons, wherein the conformable film comprises an adhesive layer applied to a second side thereof,
wherein the conformable label comformably adheres via the adhesive layer to a surface of a substrate, the surface including surface discontinuities to which the conformable label is desired to conform, the conformable label conformably remaining adhered to the surface and over the surface discontinuties for a period of about 10 days or more following application when stored at room temperature.
